(19) United States
(12) Patent Application Publication
(10) Pub. No.: US 2009/0067417 A1
(43) Pub. Date: Mar. 12, 2009

(54) Method and apparatus for supporting SIP/IMS-based femtocells

(75) Inventors: Asawaree Kalavade, Stow, MA (US); Eric E. Bomarsi, Northborough, MA (US); Jonathan A. Morgan, Groton, MA (US); Lawrence A. Palmer, Harvard, MA (US)

Correspondence Address: FULBRIGHT & JAWORSKI L.L.P, 2200 ROSS AVENUE, SUITE 2800, DALLAS, TX, 75201-2784, US

(73) Assignee: TATARA SYSTEMS, INC., Acton, MA (US)

(21) Appl. No.: 12/172,238

(22) Filed: Jul. 13, 2008

Related U.S. Application Data
(60) Provisional application No. 60/949,846, filed on Jul. 14, 2007.

(51) Int. Cl. H04L 12/66

(52) U.S. Cl. 370/356

(57) ABSTRACT

A femtocell is integrated into a core network so as to securely and efficiently deliver one or more mobile services to an end user on an existing mobile device over a broadband connection. This integration can be into a basic Internet Protocol (IP)-based network, or an IMS-based network. In an illustrated embodiment, a femtocell is integrated to a SIP- or IMS-based network using a “convergence” server. The convergence server preferably is a SIP-based fixed mobile convergence (FMC) application server that provides an all-IP approach to core network integration for femtocells. The convergence server provides a number of high level functions including secure access of an end user mobile device into the core network through the femtocell (which involves authenticating the femtocell as well as a specific end user mobile device), single number voice and messaging services (by updating an end user's location to be the femtocell), mobility (to support handover between the femtocell and macro cell networks), delivery of supplementary services (such as call waiting, call hold, caller ID, three-way calling, and the like) on the femtocell network, and the delivery of new and advanced services (such as home landline routing, mobile TV, multimedia downloads and the like).

This application is based on and claims priority from U.S. Ser. No. 60/949,846, filed Jul. 14, 2007.

### BACKGROUND OF THE INVENTION

1. Technical Field

The present invention relates generally to wireless mobility technologies and services.

2. Description of the Related Art

Indoor wireless coverage has been an industry problem for years, and vendors have unsuccessfully tried to develop relevant technology solutions for the home. Most services to date have involved micro- or pico-base stations, but these solutions are costly for residential users. Alternative approaches tried most recently involve dual-mode devices based on Wi-Fi. While technically compelling, these solutions depend on adoption of new (and expensive) handsets. To address this deficiency, femtocells have now become a compelling solution for providing indoor coverage, while also enabling extensions to offer new IP based services in the home. Femtocell access points (or 3G access points) are cellular base stations designed for use in residential environments. A femtocell is a small cellular base station typically designed for use in residential or small business environments. It connects to the service provider's network via broadband (e.g., DSL or cable) and is designed to support a number of mobile devices operating in the environment. A femotcell allows a user with an existing mobile phone to access cellular voice and data services over Internet Protocol (IP).

Femtocells allow service providers to extend the reach of their services to users within a “home zone” while leveraging the user's broadband connection. This not only allows a service operator to address coverage holes, but it also gives the operator an opportunity to potentially shape end-user behavior, e.g., by encouraging the use of 3G data services in the home femtocell, where such data services can be faster and cheaper. In addition, mobile operators can leverage the user's IP backhaul to reduce their operating expenses and spectrum costs—all without requiring any changes to the user's handset. Likewise, users stand to benefit from femtocell-based services. For simple voice and data services, an end user gets the benefit of better coverage and faster access through the use of a femtocell. Moreover, many vendors are developing technologies that allow service parity between a macro network and the femtocell network. This includes voice, SMS, data, supplementary services, voicemail, and handoff. Further, new services can be made available, such as IPTV on the mobile, remote access to home PC content, and softphone based services. The user also stands to benefit from better pricing, due to the lower operator costs and bundling.

### BRIEF SUMMARY OF THE INVENTION

The subject matter herein describes how to integrate a femtocell into a core network so as to securely and efficiently deliver one or more mobile services to an end user on an existing mobile device over a broadband connection. This integration can be into a basic Internet Protocol (IP)-based network, or an IMS-based network.

In an illustrated embodiment, a femtocell is integrated to a SIP- or IMS-based network using a “convergence” server. The convergence server preferably is a SIP-based fixed mobile convergence (FMC) application server that provides an all-IP approach to core network integration for femtocells. The convergence server provides a number of high level functions including secure access of an end user mobile device into the core network through the femtocell (which involves authenticating the femtocell as well as a specific end user mobile device), single number voice and messaging services (by updating an end user's location to be the femtocell), mobility (to support handover between the femtocell and macro cell networks), delivery of supplementary services (such as call waiting, call hold, caller ID, three-way calling, and the like) on the femtocell network, and the delivery of new and advanced services (such as home landline routing, mobile TV, multimedia downloads and the like).

The foregoing has outlined some of the more pertinent features of the invention. These features should be construed to be merely illustrative. Many other beneficial results can be attained by applying the disclosed invention in a different manner or by modifying the invention as will be described.

### BRIEF DESCRIPTION OF THE DRAWINGS

For a more complete understanding of the present invention and the advantages thereof, reference is now made to the following descriptions taken in conjunction with the accompanying drawings, in which:

FIG. 1 illustrates the components of a mobile services convergence solution for femtocell convergence;

FIG. 2 illustrates a convergence server operating in an existing SIP/IP network, where it appears as a MSC/VLR and implements SIP to mobile interworking (SIP-MSC/IWF);

FIG. 3 illustrates the convergence server within an IMS network, where it acts as a SIP application server with given interfaces;

FIG. 4 illustrates a security system for femtocell authentication;

FIG. 5 shows how the convergence server is used with an HLR, a PDIF, a femtocell and an end user mobile device to provide authentication;

FIG. 6 illustrates the convergence server operating as a SIP-MSC/IWF to provide interworking between an existing mobile core network and an existing IP/VoIP network;

FIG. 7 illustrates the convergence server as an IMS SIP application server that interfaces to the S-CSCF using the ISC interface;

FIG. 8 illustrates how the convergence server updates the HLR with its presence information so that calls directed to the mobile number are routed through the IP network to the femtocell;

FIG. 9 shows how the convergence server provides messaging interworking to handle Mobile Originated/Mobile Terminated Short Messaging;

FIG. 10 shows a high-level call flow for messaging convergence in an SIP/IP femtocell environment;

FIG. 11 illustrates how the convergence server operates as an application server providing support for a supplementary service;

FIG. 12 shows functionally how call forwarding—busy works in the convergence server;

FIG. 13 illustrates how the convergence server supports emergency services in the femtocell solution;

FIG. 14 shows control and data paths before and after the handoff from a femtocell network to a macro network;

FIG. 15 shows control and data paths before and after the handin from the macro network to the femtocell network (with the call anchored in the MSC);

FIG. 16 shows control and data paths before and after the handout from a femtocell network to a macro network (in an IMS embodiment;

FIG. 17 shows macro to femto handin anchored in the convergence server;

FIG. 18 illustrates the macro network to femto network handin anchored in the connected domain;

FIG. 19 illustrates femto to macro handover for CDMA;

FIG. 20 illustrates macro to femto handover for CDMA;

FIG. 21 illustrates femto to macro handover for UMTS;

FIG. 22 illustrates macro to femto handover for UMTS;

FIG. 23 provides a more detailed illustration of an operator-based SIP/IP solution using the convergence server and the security server;

FIG. 24 provides a more detailed illustration of an operator-based IMS solution using the convergence server and the security server;

FIG. 25 is a call flow for a USSD supplementary service;

FIG. 26 is a call flow for call forwarding unconditional (CFU) provisioning;

FIG. 27 is a femtocell call forwarding—busy call flow in a SIP environment;

FIG. 28 is a femtocell call forwarding—busy call flow for CDMA;

FIG. 29 is a call flow for call barring;

FIG. 30 is a call flow for call hold (IMS Mobile Originated).

FIG. 31 is a call flow for call hold—Mobile Originated (CDMA).

FIG. 32 is a call flow for call waiting (IMS).

FIG. 33 is an alternative embodiment in which the convergence server facilitates supplementary services with an existing VoIP feature server.

FIG. 34 provides additional details regarding voice call redirection to a femtocell according to the subject matter herein.

### DETAILED DESCRIPTION OF AN ILLUSTRATIVE EMBODIMENT

The reader's familiarity with femtocell, SIP and IMS nomenclature and functionality is presumed. A Glossary of Terms is provided at the end of this section.

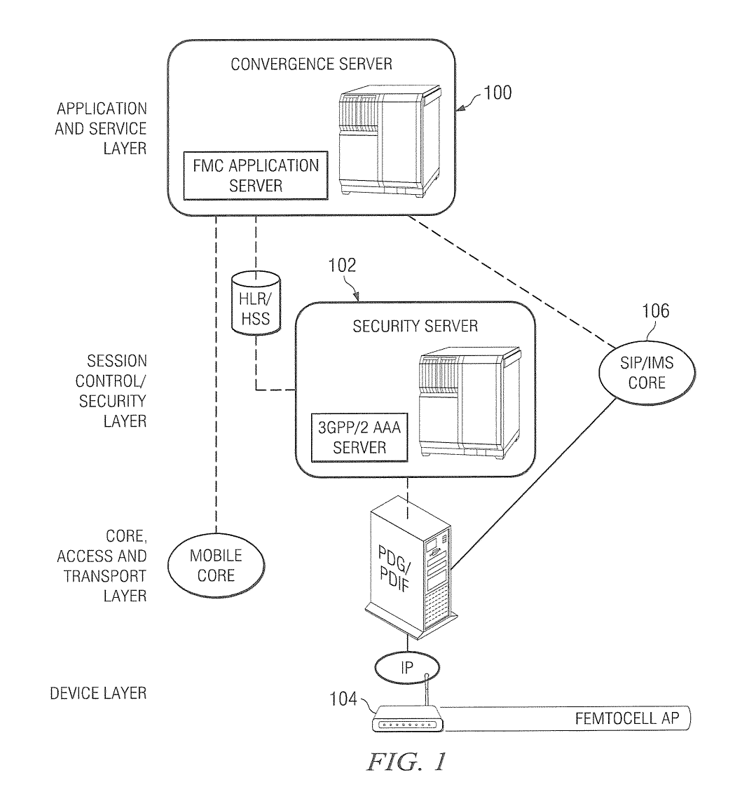

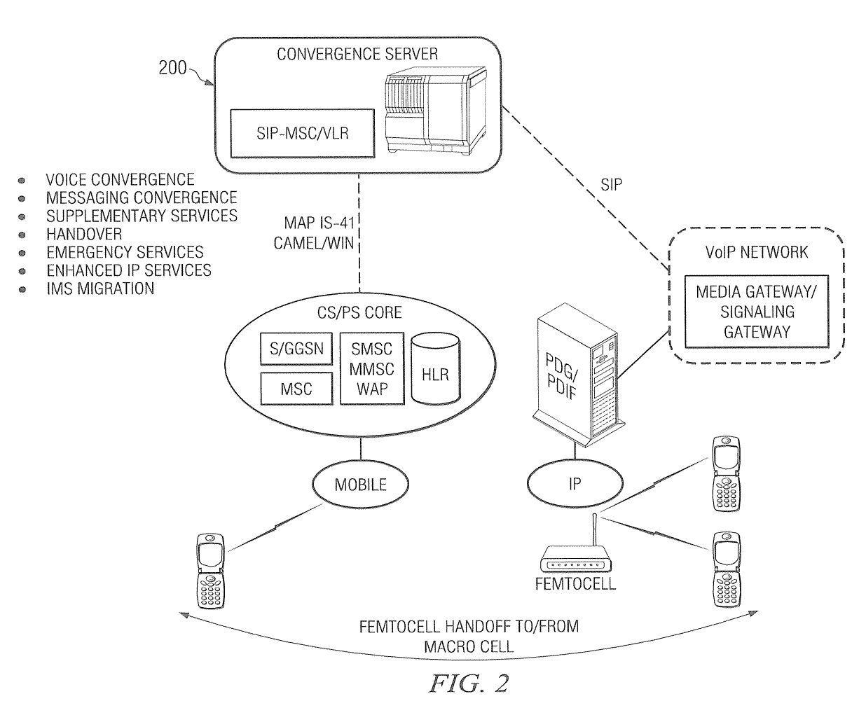

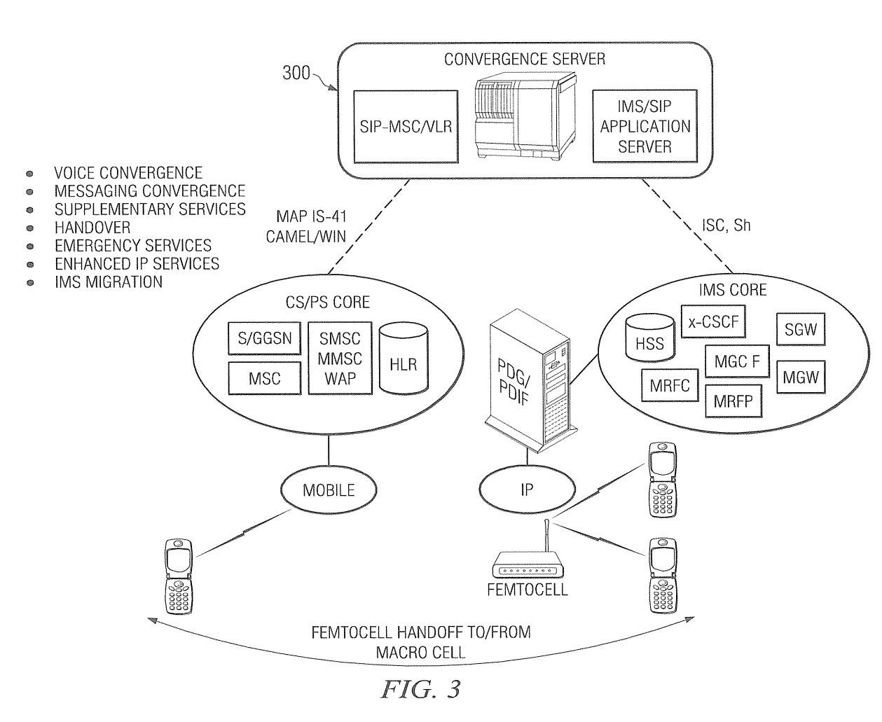

FIG. 1 illustrates the components of a mobile services convergence solution for femtocell convergence. The convergence server 100 and security server 102 are shown in the drawing as two separate entities. Note, however, that the functionality of both can be combined into a single physical element. As used herein, the convergence server (alone or together with the security server) is sometimes referred to as a gateway. The convergence server 100 is a SIP-based FMC application server that provides an all-IP approach to core network integration for femtocells. While there are several legacy architectural approaches for deploying femtocell-based solutions, the all-IP architecture preferably utilizes standard communication protocols (i.e. VoIP and SIP) and interfaces directly with the IP-based core network. This allows mobile operators to immediately achieve the end-to-end cost and service advantages that only an all-IP approach can deliver rather than being constrained by the historical limitations of traditional RAN (Radio Access Network)-based solutions. The convergence server integrates a SIP-based femtocell 104 access point into the mobile operator's core network 106 by delivering key capabilities of the service, including: updating the user's location to be the femtocell to enable voice services; providing full messaging services such as SMS; ensuring end-users have access to the same set of supplementary services (e.g. call forwarding, call waiting, call hold, and the like) on the femtocell network that they have on the macro cellular network; and handoff between the femtocell and macro cellular networks. In addition, the convergence server 100 enables enhanced IP services through a femtocell, such as SIP-based access to personal home network content. The convergence server 100 is designed to be deployable in current networks, with a graceful evolution to IMS as those networks begin to be deployed. Within today's SIP/IP network, and as shown in Error! Reference source not found., the convergence server 200 appears as a MSC/VLR and implements SIP to mobile interworking (SIP-MSC/IWF) providing, for example, the SS7 messages necessary to interface to 3G network elements such as the HLR, MSC, and SMSC.

Within an IMS network, as shown in Error! Reference source not found., the convergence server 300 acts as a SIP application server interfaces to the Serving Call Session Control function (S-CSCF) over the IMS Service Control (ISC) interface and to the Home Subscriber Server (HSS) over the 3GPP/2 defined Sh interface.

Referring back to FIG. 1, because a femtocell access point may be deployed as customer premise equipment (CPE), security and authentication concerns must be addressed. To this end, the security server 102 functions as a standard 3GPP/2 AAA security server. Preferably, it supports standard authentication protocols using methods guaranteeing end user and service provider credential security. For femtocells, the security server 102 guarantees secure access at a number of levels, including: authenticating the femtocell access point as a trusted element of the mobile network (e.g., via PDG/PDIF IPSec tunnel authentication), authenticating the end user whose mobile phone is attached to the femtocell (e.g., via SIM/AKA authentication), and service-level authorization (e.g., via interaction with both an HLR and an IMS based HSS). The primary authentication functions of the security server are now described.

As noted above, there are two aspects to authentication: authenticating the femtocell itself, and authenticating the user. Typically, there is an IPSec tunnel between the femtocell and the PDG. IPSec IKE authentication is then used to perform authentication of the femtocell. This may be SIM-based if there is a SIM in the femtocell itself. Once this tunnel is authenticated, the keys used in this tunnel authentication preferably are saved for communicating subsequent information between the femtocell and the convergence server. The user can be authenticated with the femtocell in one of several ways. One way is to use IPSec IKE tunnel setup mechanisms to authenticate the user. In this process, SIM/AKA authentication is performed using the IKE process. To provide additional security and avoid rogue femtocells, the keys derived in the first femtocell authentication exchange are saved and re-used to pass authentication keys between the TCS and the femtocell. The IKE body is then used to send authentication data. The authentication related IPSec tunnel may be torn down once the user is authenticated and the original femtocell tunnel itself is used to communicate information between the femtocell and the convergence server. Another method to authenticate the use is to use SIP or IMS based methods. In this case, the femtocell sends authentication via SIP messages to the convergence server.

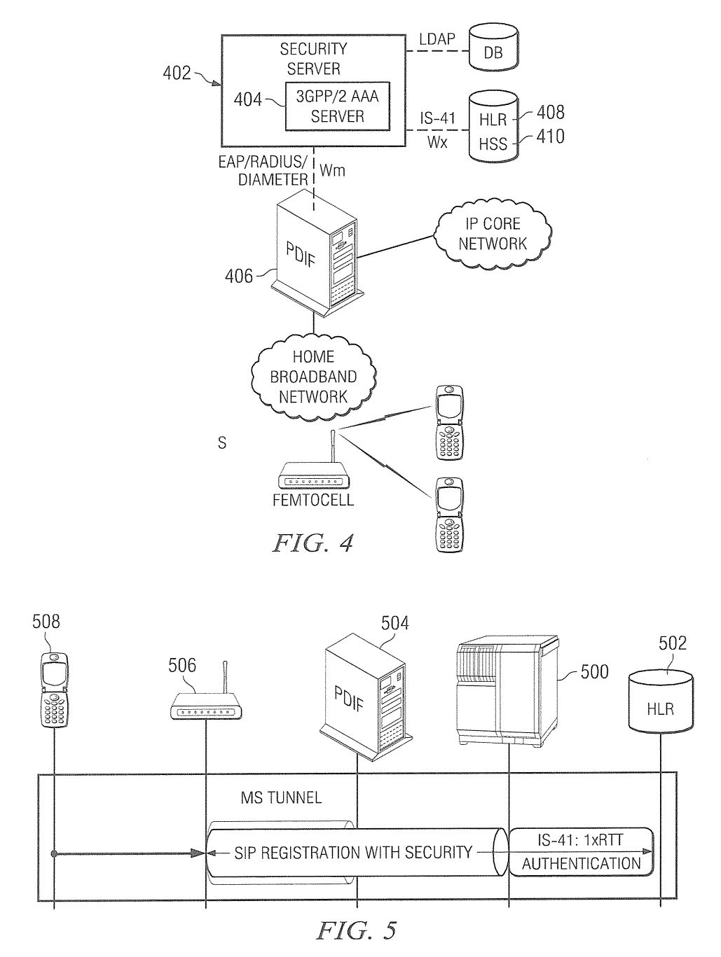

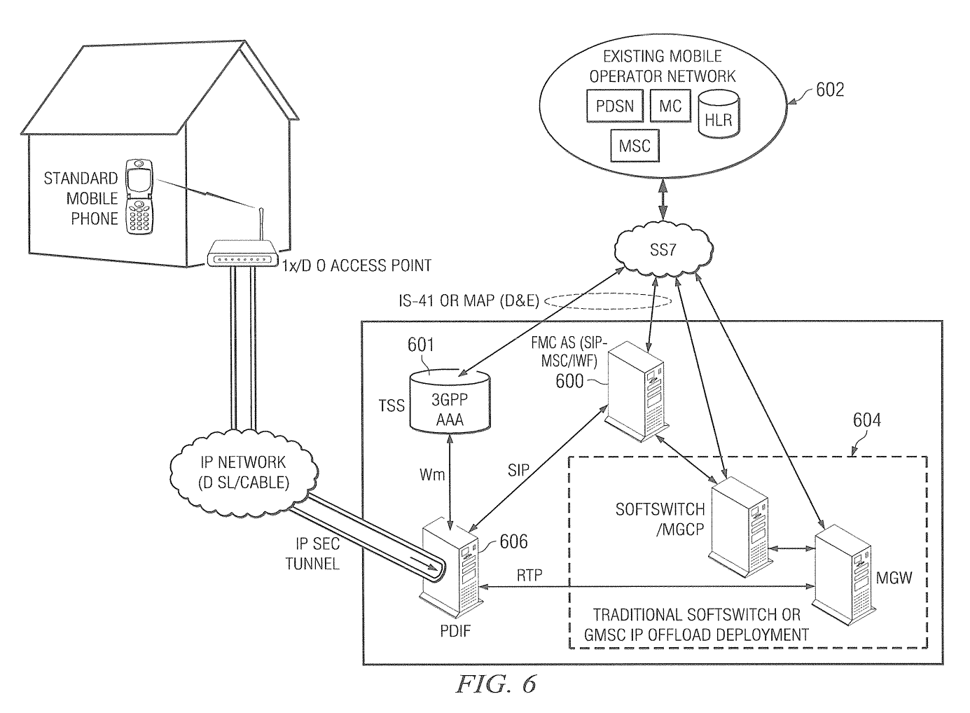

FIG. 4 illustrates a security system for femtocell authentication. As noted above, the security server 402 provides authentication and authorization together with the PDG/PDIF for femtocell solutions. The convergence server (not shown) is then used to provide authentication, e.g., based on one or the other of the approaches described above. In CDMA, the security server 402 preferably acts as a 3GPP/2 AAA server 404 interfacing to the PDG/PDIF 406 using standard RADIUS or Wm Diameter interfaces. In GSM/UMTS networks, the security server 402 also interacts with the HLR 408 using the MAP-D interface or the HSS 410 using the Wx interface for authentication. Note that the general description herein applies equally to CDMA or GSM/UMTS networks, although specific points might point to one or other technology for clarification.

Preferably, the security server 3GPP/2 AAA server 404 is located in a home network and provides authentication and authorization for IPsec tunnel establishment towards the home network. The security server 402 functionality includes the basic set defined in [3GPP TS 23.234]: retrieves authentication information and subscriber profile (including subscriber's authorization information) from the HLR/HSS of the 3GPP/2 subscriber's home 3GPP/2 network; authenticates the 3GPP/2 subscriber based on the authentication information retrieved from HLR/HSS using EAP-TLS or EAP-AKA/SIM; communicates (including updates) service authorization information for IPsec/IKEv2 tunnel establishment and user data traffic, e.g., MMS and WAP) to the PDG/PDIF; authenticates against existing customer database; generates CDRs consistent with a charging gateway preferably in multiple formats including RADIUS, GCDR, TAP3, ASN.1, and CSV (the convergence server preferably generates CDRs specific to the server functions); and interfaces to standard mobile payment systems, premium SMS or postpaid billing. In addition, the security server implements one or more femtocell extensions to support the described SIP/IMS solution, including: correlating femtocell sessions with UE sessions associated with each femtocell; and securely communicating (upon request) to the femtocell (and via the PDIF/PDG) any MS specific information.

If desired, the convergence server may provide SIP/IMS layer security for interaction with an HLR. The solution is very flexible in that it supports multiple methods of authentication for 1xRTT networks. Error! Reference source not found. shows a high level example of how the convergence server 500 is used with HLR 502, PDIF 504, femtocell 506 and end user mobile device 508.

The following provides additional details on authentication:

Approach 1: EAP/IKE AAA authentication

In this approach, UE security keys are provided to a femtocell in a voice tunnel authentication procedure. The AAA server supplies the primary keys to the femtocell through the PDG/PDIF using an EAP extension. The femtocell key is used to encrypt the UE keys to ensure only the authenticated femtocell can utilize them. The following provides additional details:
1. The femtocell establishes an IPSec tunnel to the PDG/PDIF using standard IKEv2, EAP authentication and credentials
   Both AP and AAA store keying material for subsequent UE security
   For GSM, EAP-SIM authentication is performed and the encryption key (K_encr) is stored
   For UMTS, EAP-AKA authentication is performed and the encryption key (K_encr) is stored
2. When a UE attaches to the femtocell, the AP initiates IPSec tunnel to the PDG/PDIF on behalf of the UE for voice traffic
3. Standard EAP-SIM, EAP-AKA, or EAP-TLS is used with the IMSI as the UE identity
4. The PDG/PDIF sends an EAP request to the security server via RADIUS or DIAMETER (Wm interface)
5. The security server retrieves UE authentication vectors from HLR via MAP D interface
   For AKA, the security server chooses one vector (RAND, AUTN, XRES, CK, and IK) and derived keying material (MSK, EMSK, K_aut, and K_encr) per RFC 4187
6. The security server sends an EAP challenge to the femtocell.
   1. Contains usual attributes: RAND, AUTH
   2. Adds proprietary AT_ENCR_DATA2 which contains the UE CK and IK keys AES encrypted with the K_encr of the femtocell
   3. Computes a MAC for the full message using K_aut
7. The PDG/PDIF relays the EAP-Request/AKA-Challenge to the femtocell
8. The femtocell performs air security procedures
   1. Decrypts AT_ENCR_DATA2 and retrieves UE IK and CK keys
   2. Derives UE K_aut and K_encr from IK and CK
   3. Uses K_aut to verify the MAC
   4. Triggers the UE authentication with the AUTH and RAND
9. The UE performs air security procedures
   1. Uses USIM to run UMTS AKA, verify AUTN and generate CK, IK, and RES
   2. Answers the femtocell challenge with the RES
10. The femtocell completes air security
   1. Performs security mode procedures with UE using CK for encryption and IK for integrity protection
   2. Sends EAP-Response/AKA-Challenge to PDG/PDIF containing UE RES and MAC computed from K_aut
11. The PDG sends EAP-Response to the security server in RADIUS or DIAMETER
12. The security server completes UE authentication
   1. Verifies MAC and RES
   2. Responds with EAP-Success towards PDG/PDIF
Encryption of UE IK and CK is required to prevent rogue femtocells from trying to authenticate an UE. Only an authenticated femtocell can pull keys out. Because preferably each UE is a separate tunnel, a rogue femtocell can try to act like an authenticated femtocell and grab UE keys.
   Approach 2: In this approach, the UE security keys are provided to the femtocell in the SIP registration procedure with the convergence server. The following provides additional details:
1. The femtocell establishes IPSec tunnel to the PDG/PDIF using standard IKEv2, EAP authentication and credentials
2. When a UE attaches to the femtocell, the AP performs a SIP Registration toward the P-CSCF on behalf of the UE
   1. Registers the UE IMSI associated with the authorization username of the femtocell
   2. HSS is provisioned so that femtocell can register for UE IMSI
   3. Standard IMS security is based on AKA using the femtocell authentication
   3. SIP AS authenticates the UE with a challenge encapsulated in SIP INFO message to the femtocell
   1. Contains usual attributes: RAND, AUTH
   2. Adds proprietary AT_ENCR_DATA2 which contains the UE CK and IK keys AES encrypted with the K_encr of the femto
   3. Computes a MAC for the full message using K_aut
4. The femtocell performs air security procedures
   1. Decrypts AT_ENCR_DATA2 and retrieves UE IK and CK keys
   2. Derives UE K_aut and K_encr from IK and CK
   3. Uses K_aut to verify the MAC
   4. Triggers the UE authentication with the AUTH and RAND
5. UE performs air security procedures
   1. Uses USIM to run UMTS AKA, verify AUTN and generate CK, IK, and RES
   2. Answers the femtocell challenge with the RES
6. The femtocell completes air security
   1. Performs security mode procedures with UE using CK for encryption and IK for integrity protection
   2. Sends SIP-OK to server containing UE RES and MAC computed from K_aut
7. SIP AS completes UE authentication

### Location Management

The convergence server interacts with the HLR to facilitate location management. In a SIP/IP (pre-IMS) architecture, the convergence server provides SIP-MSC/IWF functions between an existing VoIP network and the mobile operator core network. For SIP/IP, the convergence server appears to other network elements as a VLR to provide the SS7 messages necessary to interface to elements such as HLR, MSC, and SMSC in the mobile network. The interface to the VoIP network is SIP as defined by IETF RFC 3261. When operating as a SIP-MSC/IWF, such as shown in Error! Reference source not found., the convergence server 600 is the centralized SIP convergence server that provides interworking between the existing mobile core network 602 and an existing IP/VoIP network 604. The security server (as described above) is reference 601. The convergence server 600 receives SIP traffic from the access network (through a PDIF/PDG 606 and potentially through a SBC), provides SIP registration functions for the service, and preferably is the central interface point to the VoIP/Softswitch/MGCF elements sending the appropriate SIP messages. The convergence server preferably interfaces directly to the HLR, SMSC, and MSC, e.g., using the IS-41 interface for CDMA or MAP-D/E for GSM/UMTS.

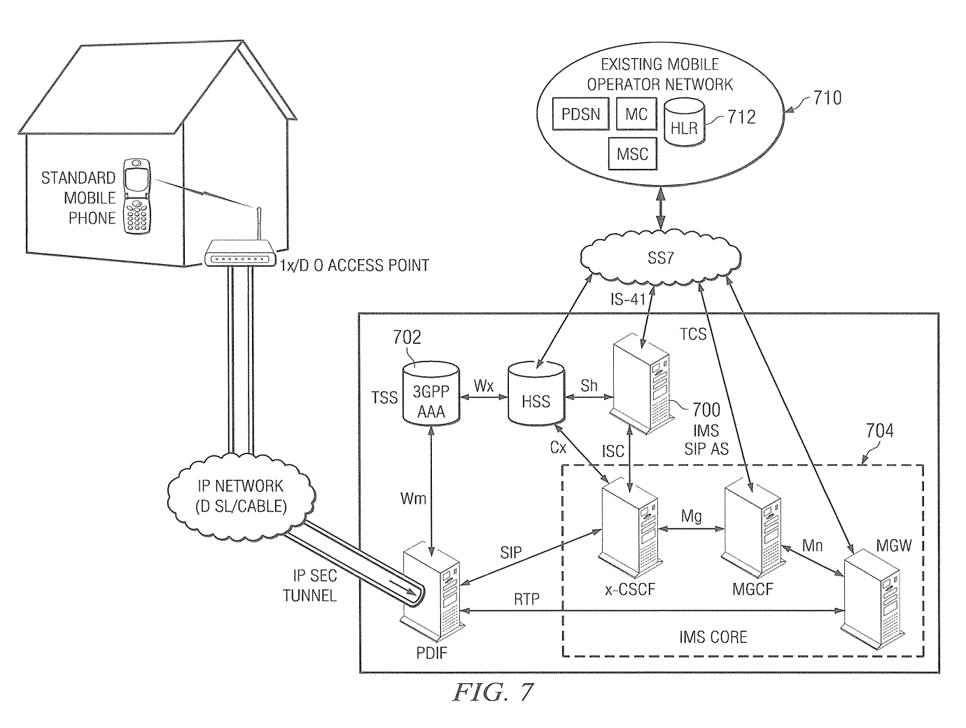

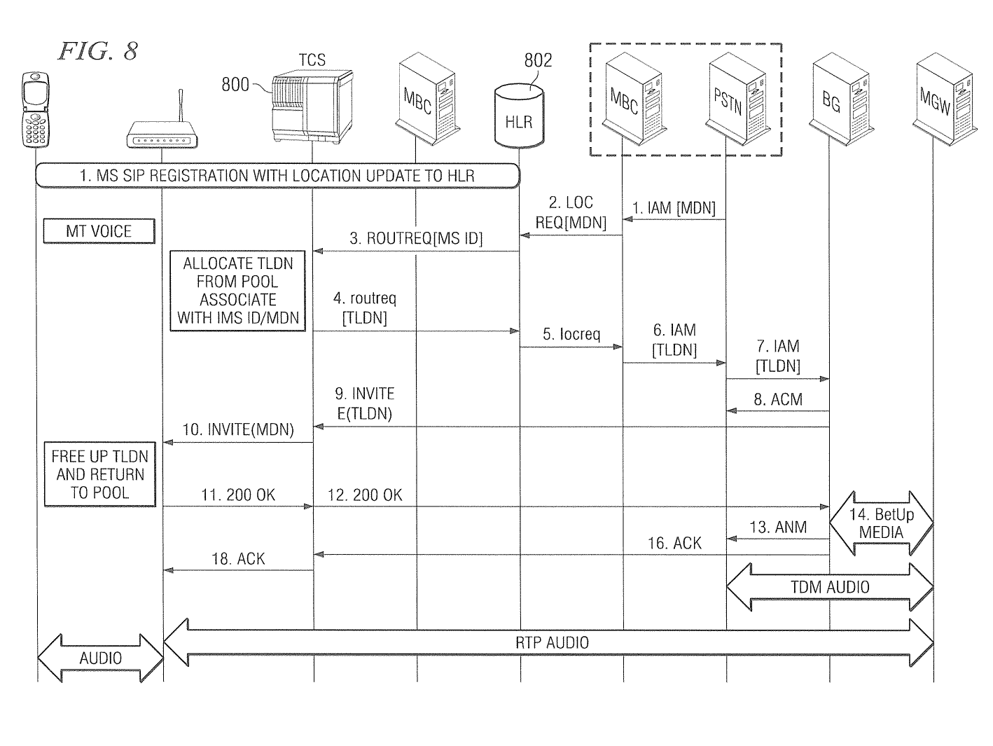

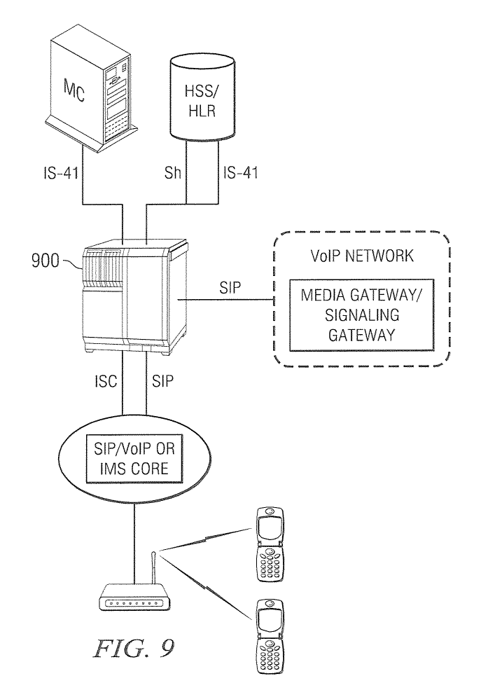

In the IMS architecture, as shown in Error! Reference source not found., the IMS infrastructure core 704 provides the centralized interface control/signaling for the solution, including SIP registration functions. In this embodiment, the convergence server 700 is an IMS SIP application server that interfaces to the S-CSCF using the ISC interface. The security server (together with its relevant interfaces) is shown as reference numeral 702. As noted above, the security server 702 provides the security piece of the solution while the convergence server 700 provides the femtocell convergence (and some security functions) piece of the solution. In an IMS network as shown in FIG. 7, the convergence server interfaces to the Serving Call Session Control Function (S-CSCF) over the ISC (IMS Service Control) interface and to the HSS (Home Subscriber Server) over the Sh interface. The same system may support both Pre-IMS and IMS networks through a global provisioning command. In this IMS architecture, the S-CSCF (and applicable I-CSCF and P-CSCF) provide the centralized IMS/SIP call control functions and the convergence server functions as an IMS SIP application server providing primarily the interaction with the existing mobile core infrastructure 710. In a pure standard IMS architecture, the convergence server still interfaces to the HLR for location updates. Even in scenarios where an HSS exists, the convergence server interfaces to the HLR and SMSC (using the IS-41 interface for CDMA, and MAP D/E for UMTS).

As a SIP-MSC/IWF and IMS application server, the convergence server provides the following services by interfacing with the HLR: voice convergence (circuit switch convergence), messaging convergence, and supplementary services that require tie-in with the existing mobile circuit switched core, and handover. Each of these services or functions is now described in more detail below.

### Voice Convergence

The solution allows voice calls to be routed to/from the mobile device connected to the femtocell using the subscriber's mobile number. The convergence server allows voice services (both call origination and termination) to be delivered or redirected over a VoIP and/or IMS network to a femtocell device in the home. The femtocell device translates the IP/SIP traffic back to circuit switched traffic. One aspect of the solution is that the convergence server updates the user's location to be the femtocell to enable voice service. The convergence server interfaces with the VoIP network over SIP. In an IMS deployment, the convergence server interfaces with an S-CSCF over the ISC interface to perform a similar function. The voice convergence solution includes several capabilities, which are now described in more detail.

The convergence server supports redirection of mobile terminated calls. As shown in Error! Reference source not found., the convergence server 800 updates the HLR with its presence information so that calls directed to the mobile number are routed through the IP network to the femtocell. The convergence server functions as a VLR and provides the appropriate routing number. The convergence server can route the call through an external VoIP network or an operator IMS network.

The following are additional voice convergence services.

For Mobile Originated calls from the femtocell, the convergence server ensures that the subscriber's mobile number is presented as the Caller ID.

The convergence server enables the subscriber to access a voice mail system and retrieve voice mail messages from the femtocell.

As part of its SMS over IP functions, the convergence server can send a Message Waiting Indicator (MWI) to the subscriber. Typically, the MWI is sent as an SMS from a voice mail system; the convergence server redirects (or duplicates) it to the femtocell.

The solution supports a full range of supplementary services. In particular, because the convergence server has access to the subscriber profile in the HLR, it has the ability to enforce call barring, call forwarding and other policies specified in the HLR. In addition, the subscriber has the ability to enable call forwarding from the client. This feature preferably gets configured to the HLR by a convergence gateway. In addition, the convergence server supports one or more additional supplementary services, including: call holding, call waiting, caller ID, call forwarding, and the like. Supplementary Services are detailed in a later section.

The solution also supports VoIP to VoIP calling where the caller and callee are both attached to femtocells. It is possible to enable this form of operation within the femtocell environment potentially offering some unique service aspects for femtocell customers. The convergence server keeps track of such calls as part of its overall CDR collection process, enabling the mobile operator to offer differentiated or tiered pricing as desired.

The convergence server can also provide emergency and location-based services. In particular, the convergence server will detect a call to an emergency number (e.g., 911) and direct the SIP call to the appropriate emergency call center.

The functionality described for voice convergence equally applies to video services. In particular, the convergence server supports to the ability to control the set up for SIP based messaging.

### Messaging Convergence

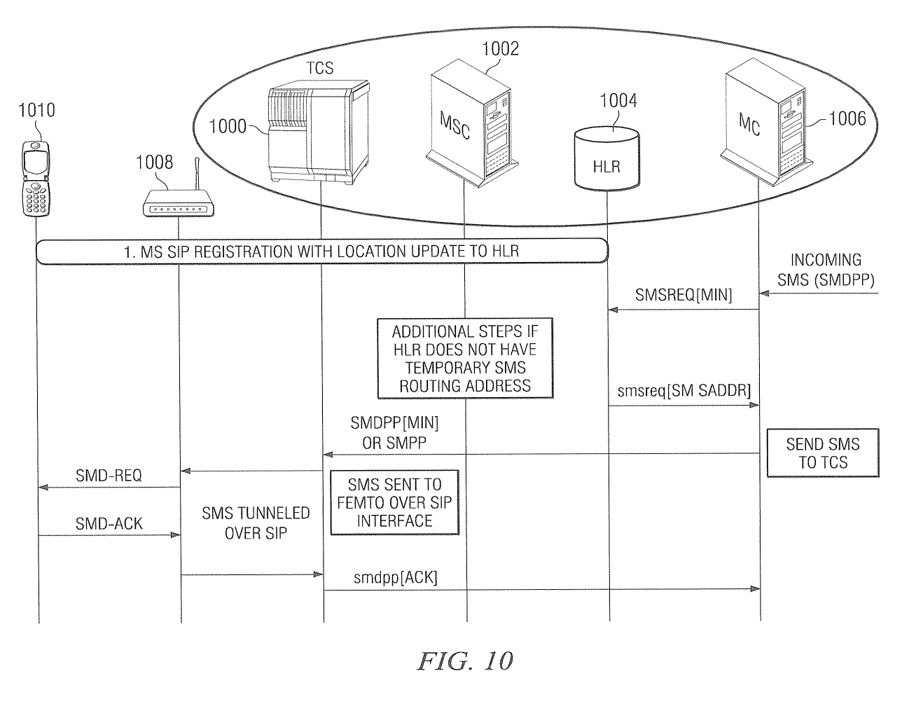

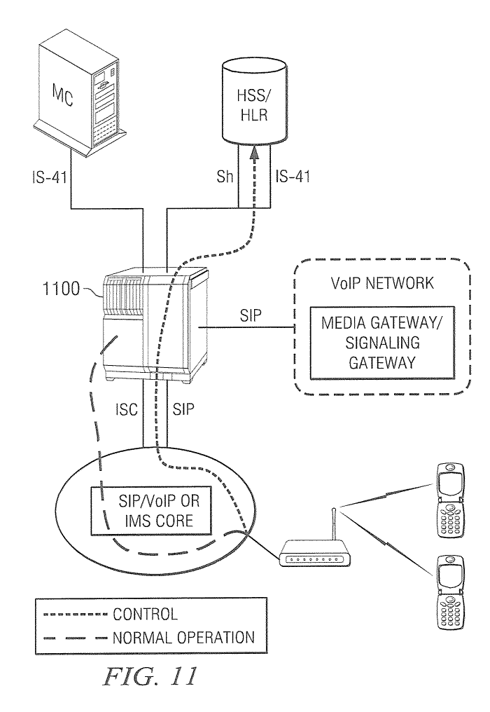

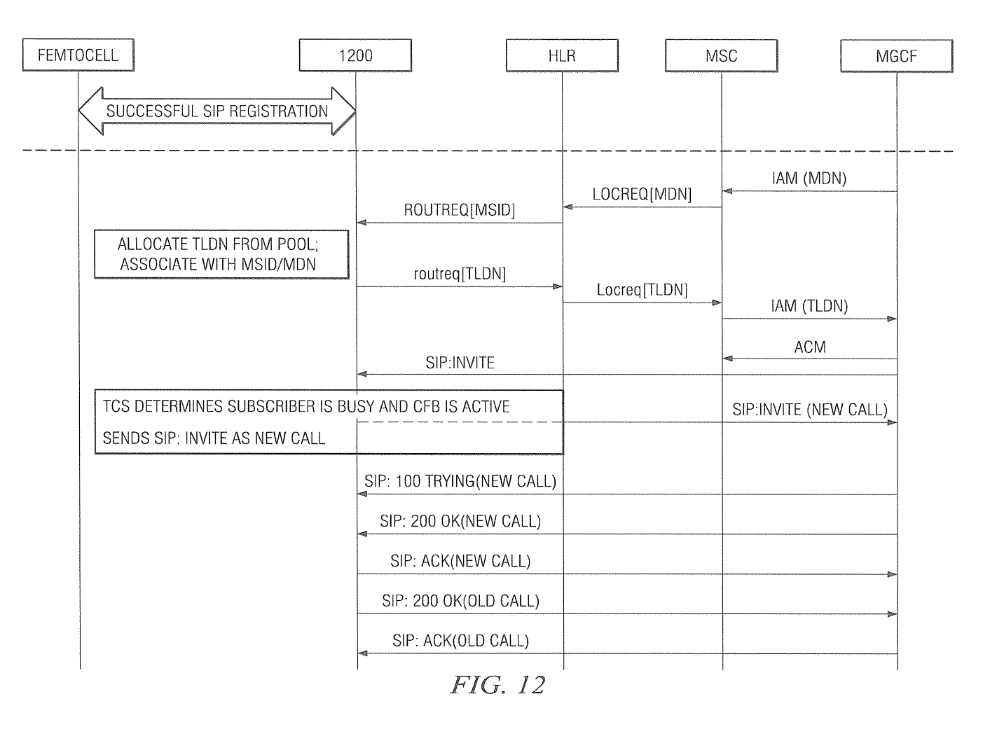

The messaging solution enables SMS (and MMS) messages over IP to the femtocell tied to the mobile number. The convergence server allows incoming Mobile Terminated (MT) messages to the mobile number to be terminated on the femtocell and, for Mobile Originated (MO) SMS messages, the user's mobile number is maintained as the source address. For the Short Message Service (SMS), as shown in Error! Reference source not found., the convergence server 900 provides messaging interworking to handle Mobile Originated/Mobile Terminated Short Messaging. The convergence server 900 is responsible for maintaining knowledge of the association between the MDN/MIN and the IP address of the UE. In most applications, the convergence server is not carrying the bearer traffic. The exception is SMS. In this case, the convergence server connects to the Message Center (SMSC), and transports the SMS over SIP. FIG. 10 shows a high-level call flow for messaging convergence in an SIP/IP femtocell environment. The convergence server 1000 is shown with the other core network elements: the MSC 1002, HLR 1004 and MC 1006. The femtocell is shown at 1008, and the mobile device at 1010. Note that the IMS case (where the convergence server interfaces directly with the S-CSCF) is the same concept, except all the SIP messages go through the S-CSCF from the convergence server 1000. In a pre-IMS environment, basic redirection of SMS and voice to the IP femtocell network can be supported directly with a MSC/VLR approach. To receive the SMS for the selected MS within the femtocell, the convergence server updates the user's location within the HLR. As a result, the SMSC delivers the SMS to the convergence server. The convergence server, in turn, sends the SMS to the femtocell as SIP message notifications. The call flow shows the convergence server interfacing with the SMSC using IS-41. The server can also interface with an SMSC over SMPP. From a standards perspective, the solution is consistent with work being defined in 3GPP and 3GPP2. In particular, the approach can be used to offer services without any changes to the core network.

### Supplementary Services

Supplementary services are value-add capabilities offered to subscribers over and above the simple ability to make and receive calls. One of the functions of the convergence server is to operate as an application server providing support for a supplementary service, as shown in Error! Reference source not found. In this embodiment, the convergence server 1100 focuses on interworking of SIP-based messages from the IP device with CDMA (and GSM) circuit switched services associated with the HLR. The convergence server 1100 supports supplementary services both for pre-IMS SIP/IP and IMS. In the pre-IMS mode, the convergence server uses standard SIP to interact with the femtocell and the existing VoIP network. In the IMS mode, the convergence server operates as an IMS SIP application server for supplementary services. Supplementary services, as described in 3GPP2 and 3GPP, are a recommended set of services that support Teleservices and Bearer services that will be supported by a Public Land Mobile Network (PLMN) in connection with other networks. All supplementary services supported by the convergence server in the femtocell environment conform to the relevant aspects of this specification.

The following provides additional details regarding supplementary services operation. There are two general categories with respect to the functional operation of supplementary services: control procedures, which involve the provisioning or setting up of the supplementary service (for example, signaling the HLR to forward a call to certain number) and normal operation procedures, which involve the operation of the system when a supplementary service is enabled. The solution focuses on the supplementary services that require anchoring with existing mobile network infrastructure/elements, e.g., HLR, SMSC. Control procedures are widely used by both users and mobile operators to provide additional services to the subscriber. The convergence server is used to support the various control procedures. The solution is designed to support one to many supplementary services. In one mode of operation, the mobile operator may be either deploying a VoIP network from scratch or partnering with a 3^{rd} party VoIP provider. In this scenario, no feature server has been deployed. The convergence server is designed to support all of the services as a standalone application server. This includes the control procedures plus the normal operations or bearer supplementary services. In alternative scenarios, the convergence server is a proxy to a Media Gateway or IMS nodes. At a minimum the convergence server determines the subscription status of the user and enforces subscription policy.

Error! Reference source not found. shows functionally how call forwarding—busy works in the convergence server 1200. Note that this procedure could originate in either direction, namely, at the femtocell, or at the Media Gateway Control Function (MGCF). Origination at the femtocell is shown in the figure. As shown, the femtocell sends a message within an existing call to indicate a Call Hold. The convergence server determines the subscription status from the HLR (whether the user is allowed to use Call Hold). If the service is allowed, the convergence server forwards the appropriate SIP message and normal SIP interaction takes place through the network. If the convergence server determines that the subscriber is not allowed to use Call Hold, the convergence server blocks the service from working through the appropriate SIP messages.

Emergency services are supported with the femtocell solution described herein. With the SIP/IMS approach, to make emergency calls to the circuit switched network, the convergence server supports interworking for signaling (MGCF), location retrieval (GMLC) and voice traffic (MGW). The convergence server provides a SIP application server for emergency calls that provide emergency service functionality as defined in 3GPP TS 23.167. The solution supports both SIP/IP (pre-IMS) versions of this functionality and IMS versions of this functionality. One important aspect of emergency calling is to determine the location of the caller. One method of determining the physical location of the caller is to map the femtocell to the physical DSL port on which the femtocell communicates, e.g., using TR-069. Another method is to use the macro cell ID. Both mechanisms can be used by the convergence server. The convergence server provides the following functions both in the SIP/IP and IMS cases: Emergency CSCF (handling the routing of emergency requests to the correct emergency center: Location Retrieval Function (LRF) (handling the retrieval of location information for the UE); and Routing Determination Function (RDF) (providing the proper emergency center destination address.

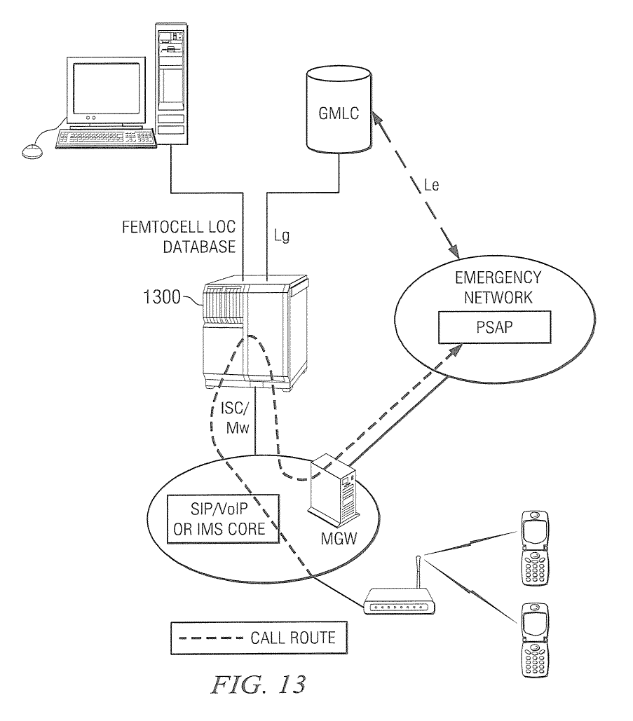

FIG. 13 illustrates how the convergence server supports emergency services in the femtocell solution. As can be seen, the server 1300 retrieves and stores the geographic coordinates for the femtocells from a database of the femtocells (the interface to this database can be of various types, including XML, LDAP, and RADIUS) and stores the information locally. The server stores the closest emergency call center coordinates (allowing the convergence server to route the emergency calls to the nearest center). The server also functions to detect the emergency call setup by analyzing the dialed numbers in a SIP INVITE message. From the INVITE message, the server obtains the femtocell IMSI of where the UE is located. It then routes the emergency call to the relevant call center (based on femtocell coordinates). The convergence server also provides location information to/from the GMLC (if available) using an Lg interface, and it selects the PSAP closest to the femtocell geographical coordinates. In the event no femtocell location information is available, the convergence server selects the default emergency center.

### Mobility

The convergence server also supports mobility between the macro and the femtocell network. Specifically, the server is designed to support both handoff and handin of calls. The convergence server also has the ability to capture usage information for both legs of the call so appropriate usage records can be generated. The overall architecture of the femtocell handover described in this section applies to both CDMA and UMTS based femtocell architectures. Specific call flows showing different messages for specific technologies are also included. By way of background, existing standards such as VCC cannot be used to offer handoff for femtocells, and there is a need for a new method for handing handoff for femtocells. Specifically, standards in 3GPP in related areas such as VCC and LTE-GERAN handoff do not apply to the femtocell environment. Specifically, VCC as defined for dual mode devices does not apply to femtocells due to several reasons: (a) VCC is defined for dual radio systems (b) VCC assumes UE initiated handoff and (c) VCC assumes VCC compliant new handsets. In the case of femtocells, there is a need to support single radio, legacy handsets. In femtocells, the UE is always engaged in a CS call—it gets converted to a VoIP call at the femtocell AP. Hence, the femtocell AP needs to get involved in the handoff. Moreover, in the CDMA space, there are approaches such as A21 based handoff (defined for a PS VoIP call handoff to a CS 1xRTT handoff for single radio handsets) that cannot support 1xRTT and EVDO simultaneously. In this approach, the A21 interface is used by the EVDO RAN to communicate with the 1X network to establish handover. While this method can also be applied to femto handovers, in the short term this may not apply because this approach requires modifications to the RAN infrastructure to support A21. Further, the handoff is also defined only in one direction and needs software upgrades on the handset.

This section describes a preferred approach for handover. The section is organized to show both a pre-IMS solution as well as an IMS solution. In each case, both handout and handin are described. In the IMS case, there are two ways to anchor calls and both are discussed. Finally, several detailed diagrams show representative call flows messages for 3GPP and 3GPP2 networks. As will be seen, the preferred approach for mobility comprises several principles: the solution works with existing handsets and existing core network elements, the solution works in an IMS as well as in SIP-based architecture, the solution preferably uses inter-MSC handoff methods to achieve seamless behavior, and the solution is deployed as a SIP application server in IMS.

The following is a representative sequence for handout in pre-IMS (with TCS referring to the convergence server):

1. UE engaged in a call over femto network
1. UE establishes a CS connection to Femto AP
2. Femto AP sends SIP messages to TCS
3. TCS interworks voice call via VoIP network

2. Handover request initiation:
1. UE detects a stronger signal and sends radio measurement to Femto AP
2. Femto AP sends measurement including target BSC to TCS

3. Handover request processing:
1. TCS determines target MSC and sends a Handover request to target MSC
2. Target MSC requests channel setup with target BSC
3. On establishing link at target BSC, the target MSC returns the handover setup message to TCS with a handover number

4. Handover leg establishment:
1. TCS sends a invite to the handover number via the MGCF
2. MGCF converts it to an IAM message to the target MSC
3. Target MSC establishes call with MGCF

5. Handover establishment
1. TCS sends the radio channel of the target cell to the UE via the Femto
2. UE establishes a call with the new BSS

6. Handover completion
1. Target MSC receives HO info from BSS
2. The target MSC sends request to TCS
3. TCS sends keys to target MSC
4. TSS drops the call leg through the Femto

7. Call is established
1. SIP signals are anchored at the TCS
2. Bearer traffic is delivered via MGW

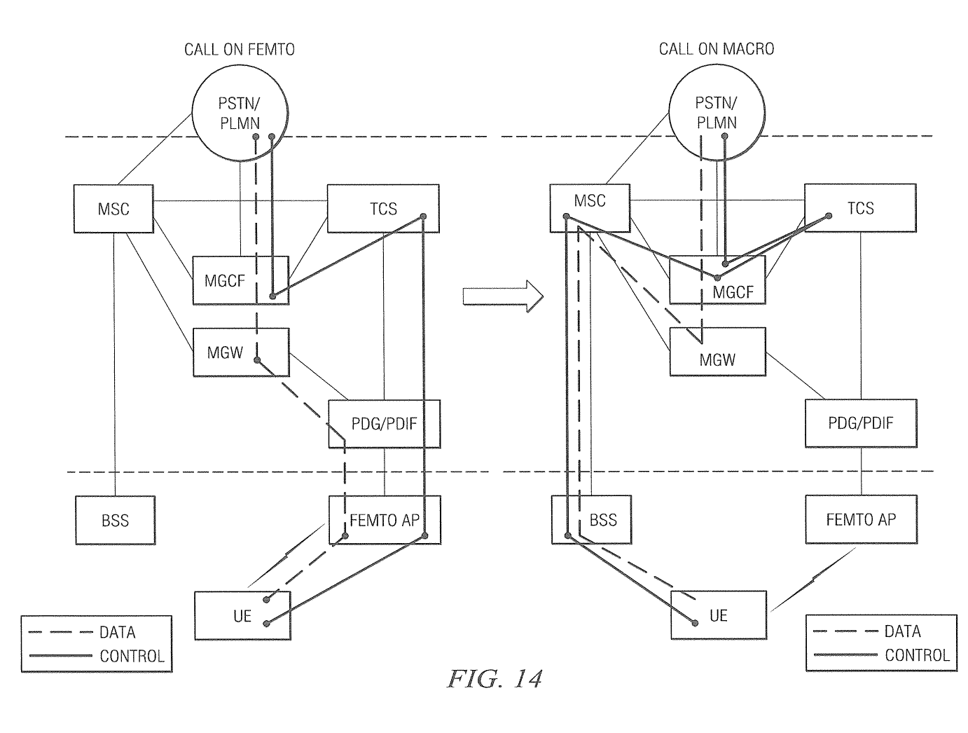

FIG. 14 shows the control and data path before and after the handoff from a femtocell network to a macro network.

The following is a representative sequence for handin in pre-IMS:

1. UE engaged in a CS call over macro network
1. UE establishes a CS connection to BSS
2. Regular CS call over the macro network

2. Handover request initiation:
1. UE detects a stronger signal and sends radio measurement to BSS
2. BSS sends request to MSC

3. Handover request processing:
1. MSC determines target MSC and sends a Handover request to target MSC (=TCS)
2. Target MSC sends Handover number of MGCF to the MSC
3. MSC sends Femto information to UE

4. Handover leg establishment:
1. MSC sends a IAM to the handover number at the MGCF
2. MGCF converts it to a SIP Invite message to the target MSC
3. Target MSC establishes call with MGCF

5. Handover establishment
1. MSC sends the radio channel of the target cell to the UE via the BSS
2. UE establishes a call with the new BSS
3. The UE is authenticated (location update in HLR)
4. Femto converts to SIP and connects to TCS

6. Handover completion
1. Call is bridged via MSC

7. Call is established and bearer traffic delivered via MGW

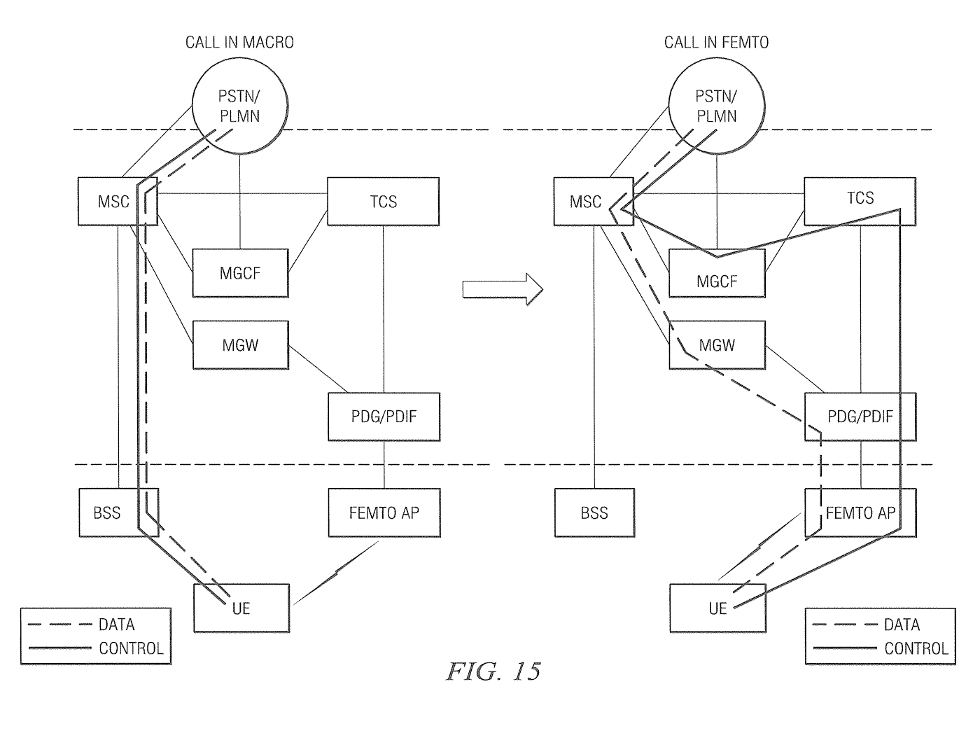

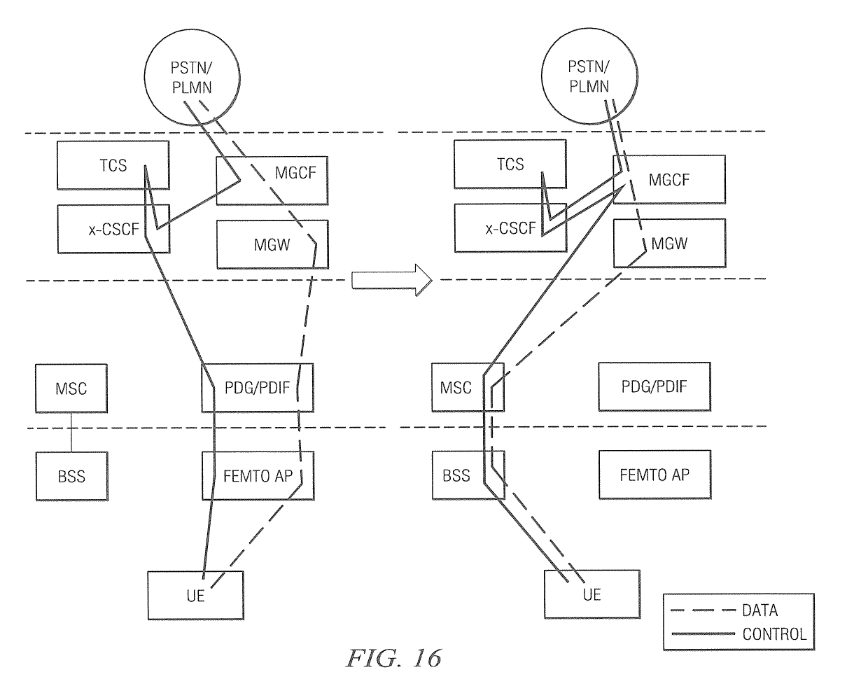

FIG. 15 shows the control and data path before and after the handin from the macro network to the femtocell network (with the call anchored in the MSC).

The following is a representative sequence for handout in an IMS network:

1. UE engaged in a call over Femto network
1. UE establishes a CS connection to Femto AP
2. Femto AP sends SIP messages to TCS via CSCF
3. IMS network, including MGCF/MGW, deliver the call

2. Handover request initiation:
1. UE detects a stronger signal and sends radio measurement to Femto AP
2. Femto AP sends measurement including target BSC to TCS via CSCF (Initial Filter criteria direct messages to the TCS AS)

3. Handover request processing:
1. TCS determines target MSC and sends a Handover request to target MSC (directly over E interface)
2. Target MSC requests channel setup with target BSC
3. On establishing link at target BSC, the target MSC returns the handover setup message to TCS with a handover number

4. Handover leg establishment:
1. TCS sends a invite to the handover number via the CSCF to MGCF
2. MGCF converts it to an IAM message to the target MSC
3. Target MSC establishes call with MGCF

5. Handover establishment
1. TCS sends the radio channel of the target cell to the UE via the Femto
2. UE establishes a call with the new BSS

6. Handover completion
1. Target MSC receives HO info from BSS
2. The target MSC sends request to TCS
3. TCS sends keys to target MSC

7. Call is established
1. SIP signals are anchored at the TCS
2. Bearer traffic is delivered via MGW

FIG. 16 shows the control and data path before and after the handout from a femtocell network to a macro network (in an IMS embodiment).

Handin from the macro network to the IMS network can be accomplished in one of two ways depending on whether the macro call is anchored in the TCS or not. The first approach anchors all calls into the convergence server. This has a large overhead, and an alternative approach to address this issue is also described below

The following is a representative sequence for handin from the macro network to the femto network (IMS anchored):

1. UE establishes a call over CS network
1. Call origination trigger in MSC invokes a request to the TCS, which sends a IMS roaming number to MSC and MSC then establishes call via MGCF
2. Call is anchored in TCS via a call origination trigger that establishes the call via the MGCF

2. Handover request initiation:
1. UE detects a stronger signal and sends radio measurement to MSC and provides Femto AP as target BSS

3. Handover request processing:
1. MSC determines target MSC as TCS and sends a Handover request to target MSC (directly over E interface)
2. The TCS returns the handover setup message to MSC with a handover number

4. Handover leg establishment:
1. MSC sends a invite to the handover number via the CSCF to MGCF
2. MGCF converts it to an SIP message and delivers to the TCS via CSCF
3. Target MSC establishes leg with MGCF

5. Handover establishment
1. MSC sends the radio channel of the target cell to the UE via the BSS
2. UE establishes a call with the Femto (after authentication—the delay for this is TBD)

6. Handover completion
1. The TCS sends handover complete message to MSC

7. Call is established
1. SIP signals are anchored at the TCS
2. Bearer traffic is delivered via MGW

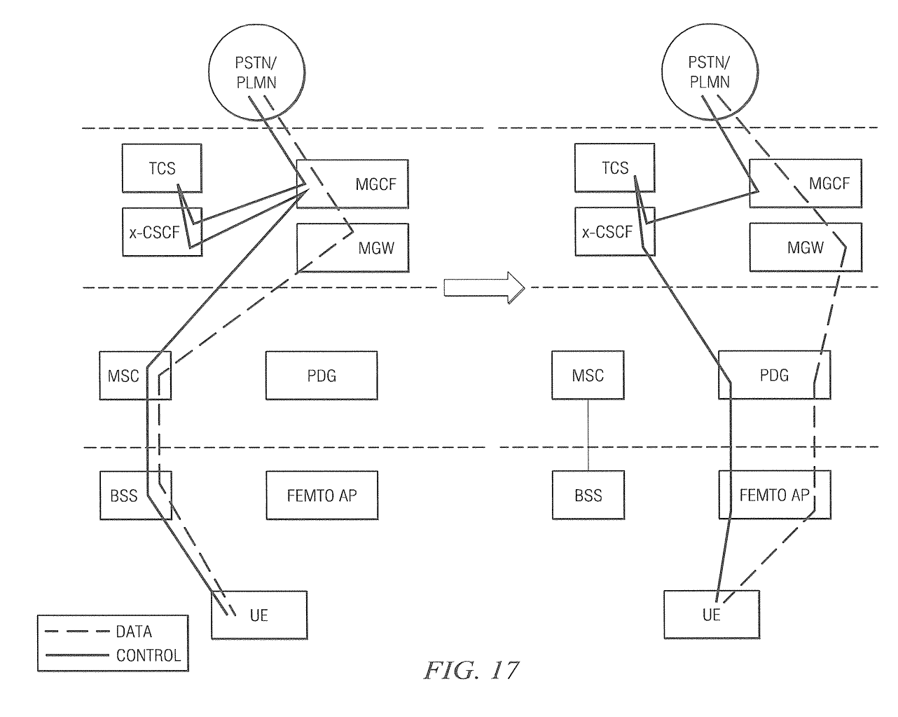

FIG. 17 illustrates the above-described approach for macro to femto handin anchored in the convergence server.

The following is a sequence for an alternative to the previous approach. Here, the handin from the macro network to the femto network is connected domain-anchored:

1. UE establishes a call over CS network

2. Handover request initiation:
1. UE detects a stronger signal and sends radio measurement to MSC and provides Femto AP as target BSS

3. Handover request processing:
1. MSC determines target MSC as TCS and sends a Handover request to target MSC (directly over E interface)
2. The TCS returns the handover setup message to MSC with a handover number

4. Handover leg establishment:
1. MSC sends a invite to the handover number via the CSCF to MGCF
2. MGCF converts it to an SIP message and delivers to the TCS via CSCF
3. Target MSC establishes leg with MGCF

5. Handover establishment
1. MSC sends the radio channel of the target cell to the UE via the BSS
2. UE establishes a call with the Femto (after authentication—the delay for this is TBD)

6. Handover completion
1. The TCS sends handover complete message to MSC

7. Call is established
1. Call is anchored at the MSC

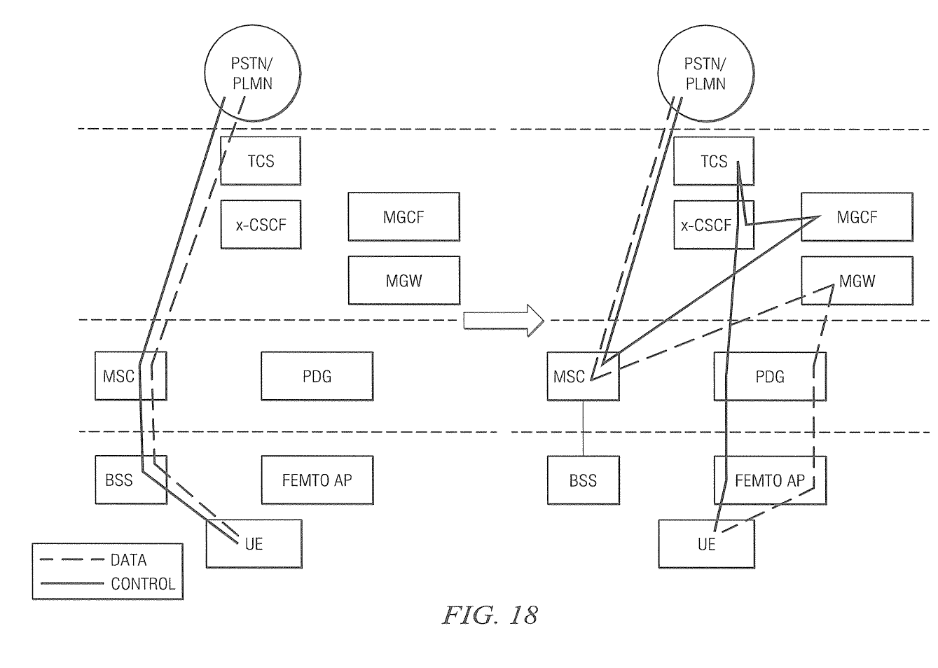

FIG. 18 illustrates the macro network to femto network handin anchored in the connected domain.

In comparing the pre-IMS and IMS cases, it can be seen that the basic call flows are similar except in the latter case they go through the S-CSCF. The convergence server interfaces with the MSC and the CS network (over a standard E inter-MSC interface) preferably is used for both approaches. In a VCC/IMS-based approach, all calls for femto VCC capable UEs are anchored in the convergence server.

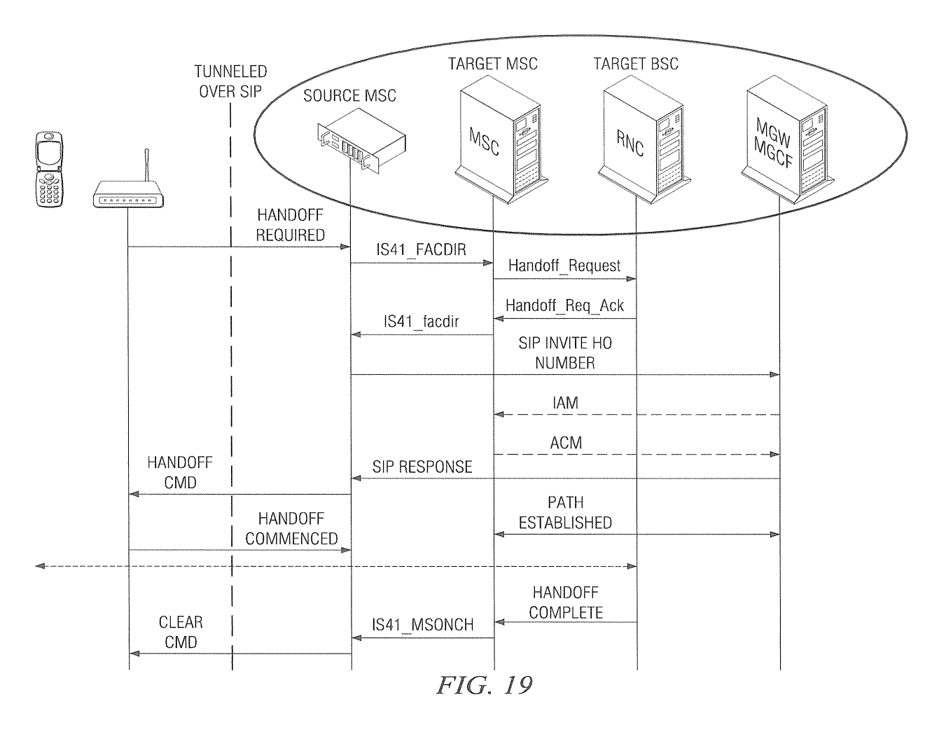

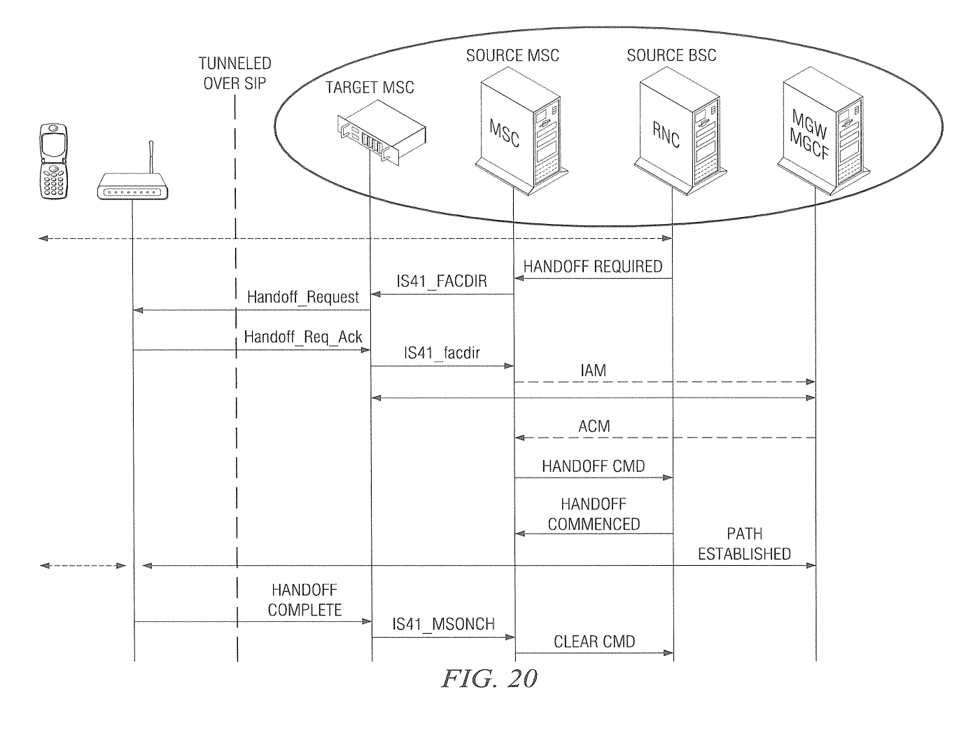

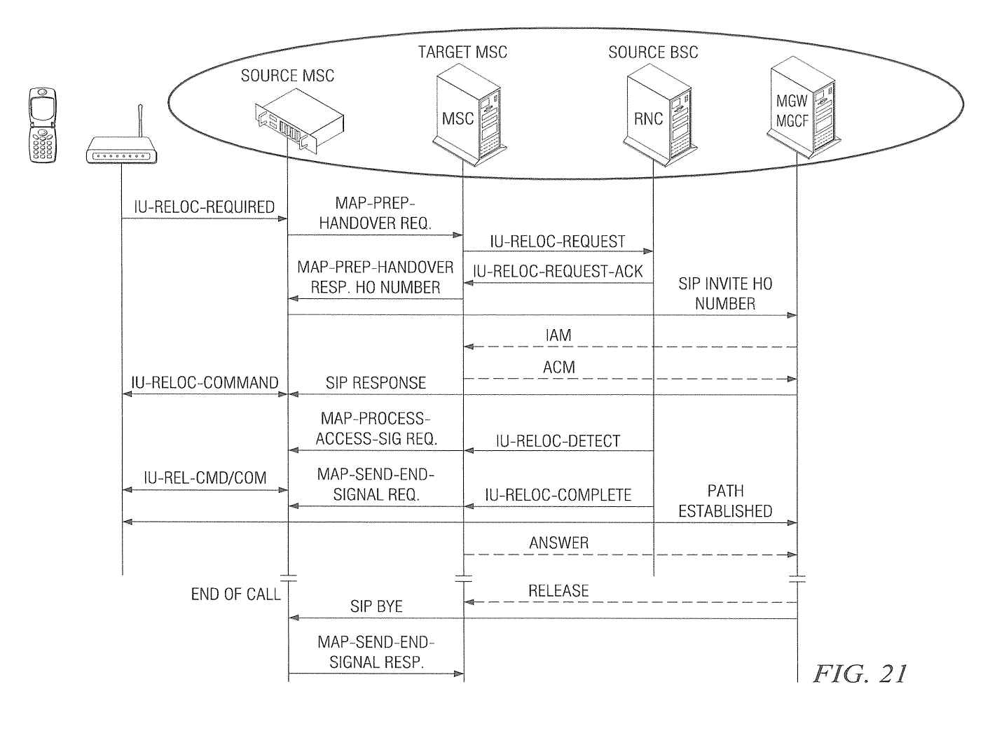

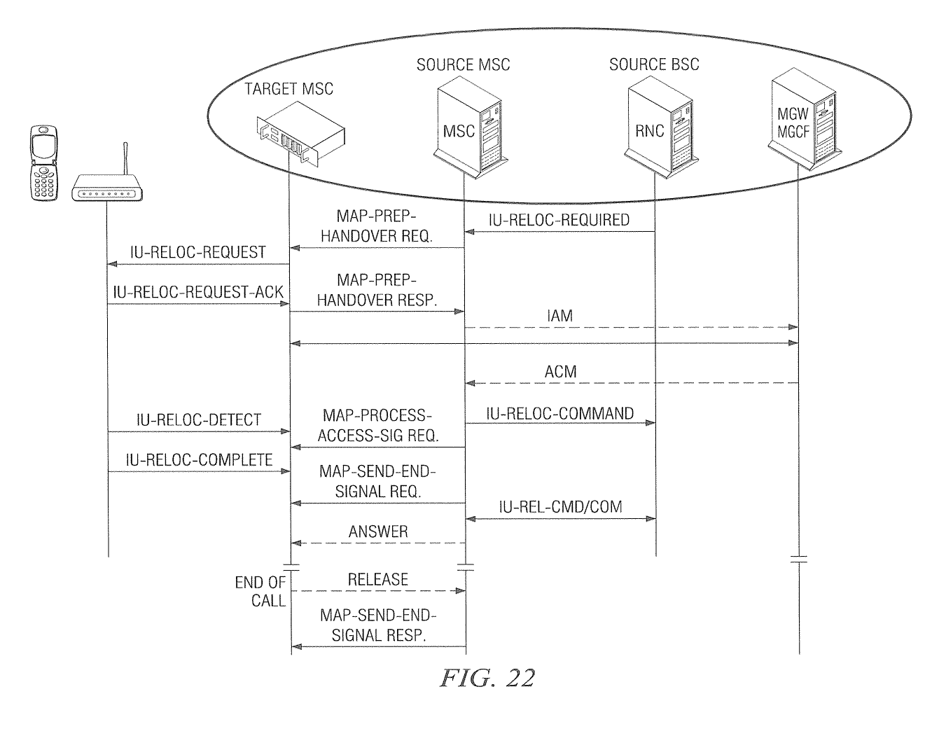

FIGS. 19-22 illustrate specific details of the call flows for UMTS and CDMA networks. In particular, FIG. 19 illustrates femto to macro handover for CDMA. FIG. 20 illustrates macro to femto handover for CDMA. FIG. 21 illustrates femto to macro handover for UMTS. FIG. 22 illustrates macro to femto handover for UMTS. Note that the handoff required message between the femtocell and the convergence server as shown in FIGS. 19 and 20 either could be tunneled CDMA/UMTS handoff messages or could be SIP messages conveying handoff requirements. For instance, FIGS. 21 and 22 show the UMTS “Iu relocation” messages being tunneled over SIP between the femtocell and the convergence server. Alternatively, the femtocell could convert that message to a SIP Update/Refer type message as well for communication between the femtocell and the convergence server.

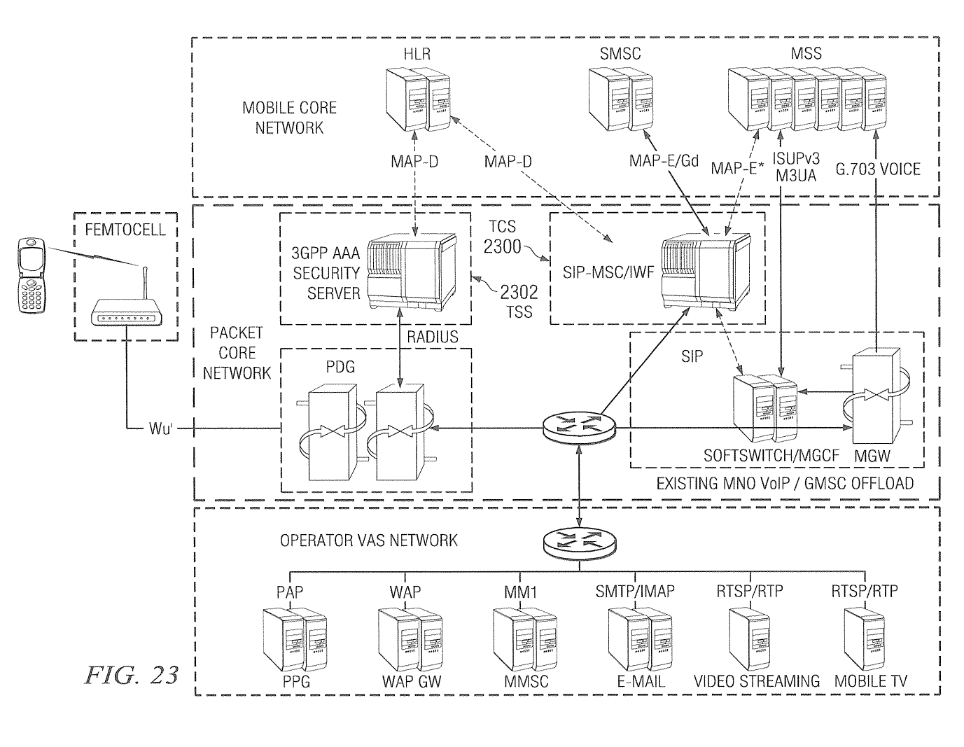

FIG. 23 provides a more detailed illustration of an operator-based SIP/IP solution using the convergence server 2300 and the security server 2302.

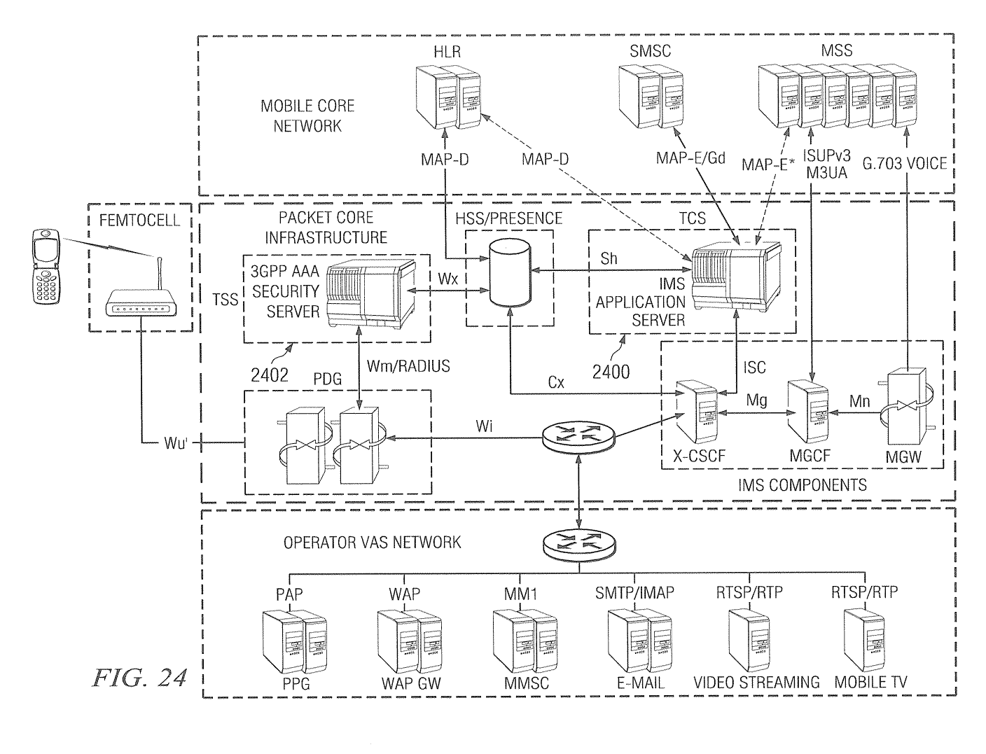

FIG. 24 provides a more detailed illustration of an operator-based IMS solution using the convergence server 2400 and the security server 2402.

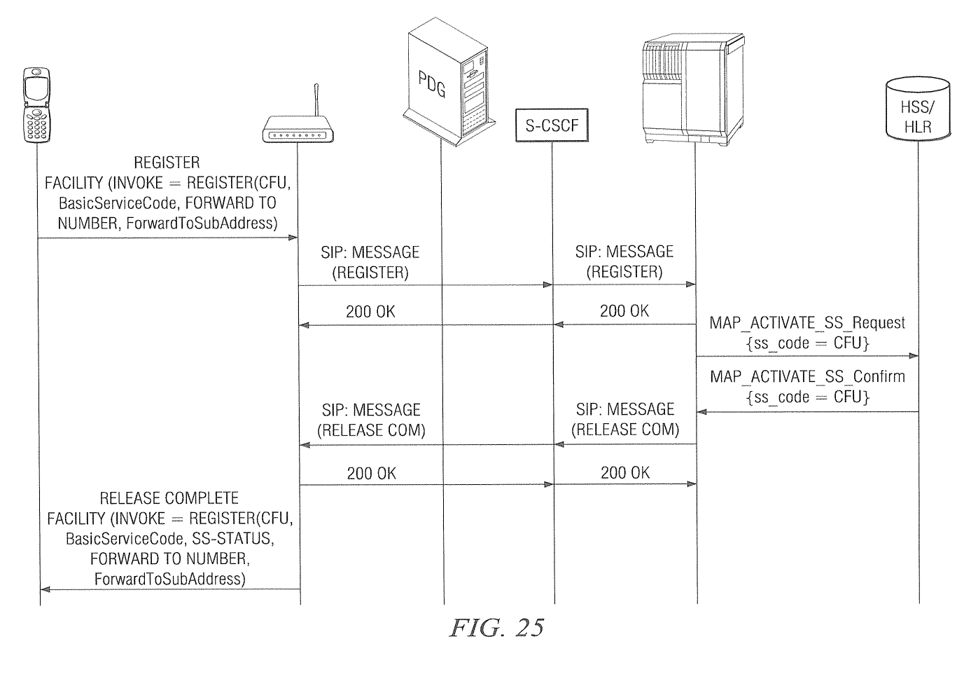

FIG. 25 is a call flow for a USSD supplementary service.

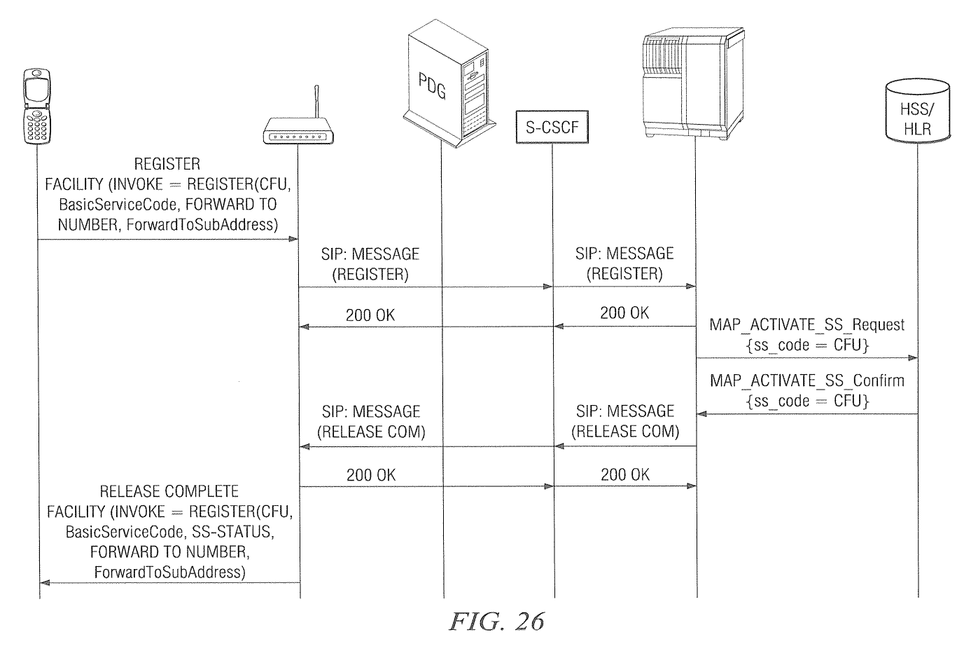

FIG. 26 is a call flow for call forwarding unconditional (CFU) provisioning.

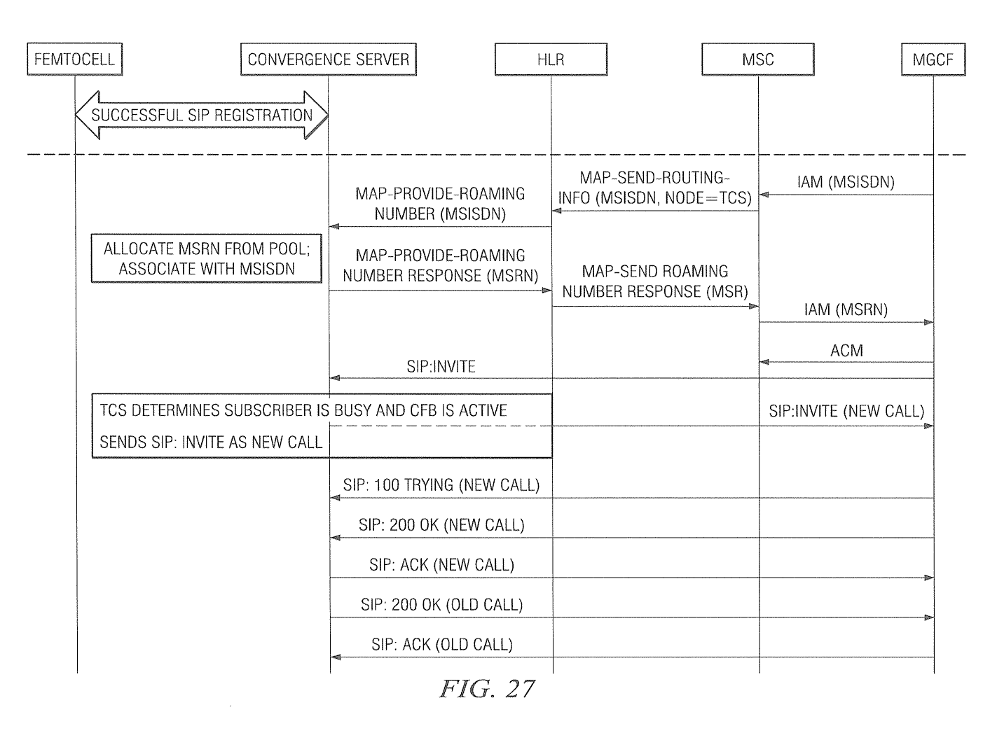

FIG. 27 is a femtocell call forwarding—busy call flow in a SIP environment.

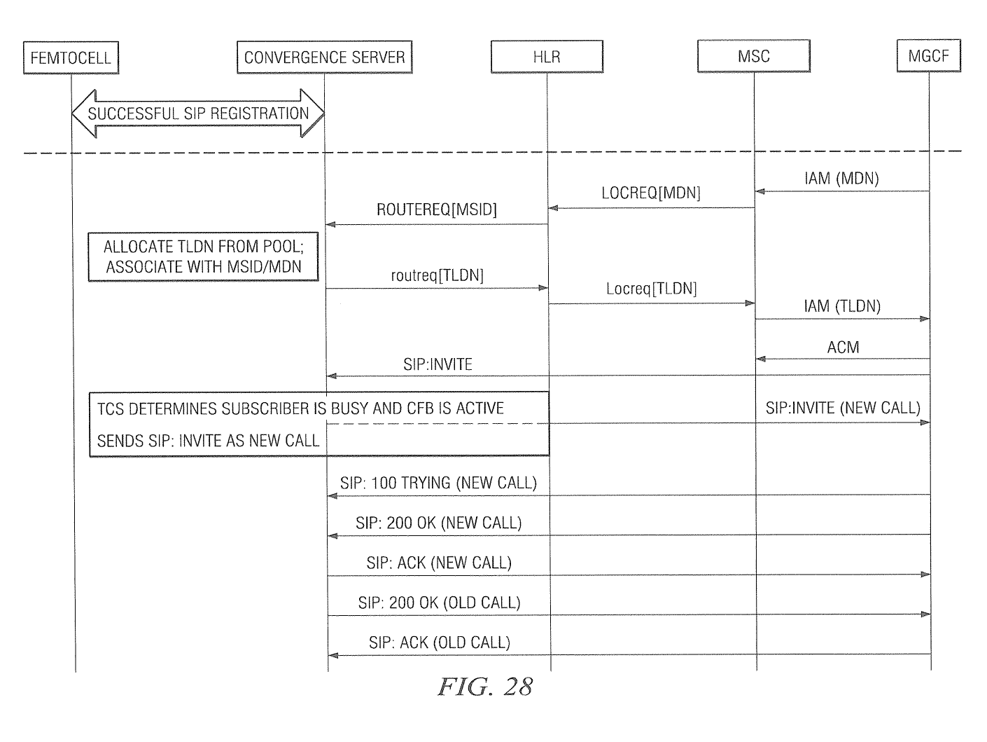

FIG. 28 is a femtocell call forwarding—busy call flow for CDMA.

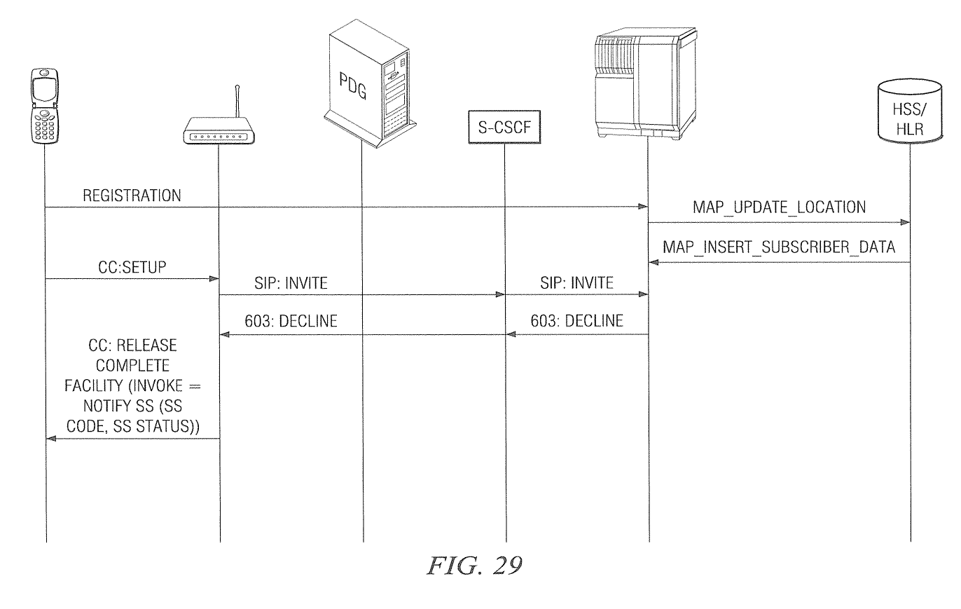

FIG. 29 is a call flow for call barring.

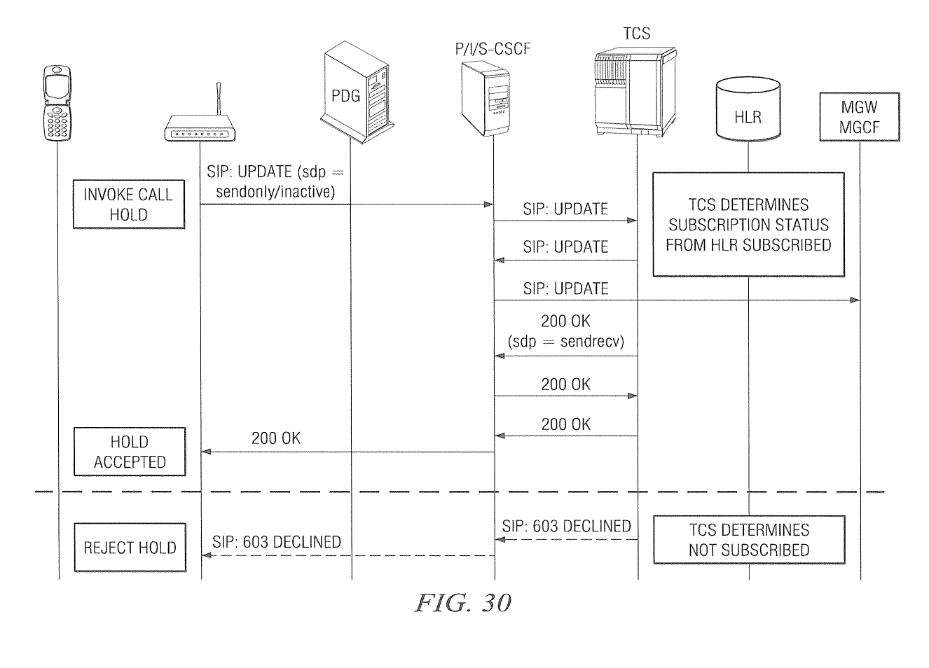

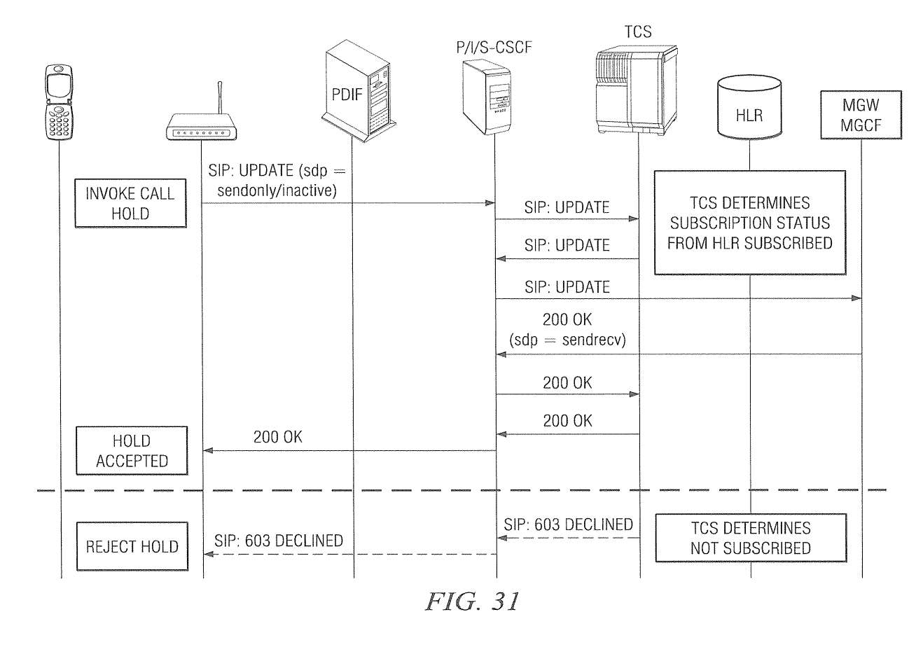

FIG. 30 is a call flow for call hold (IMS Mobile Originated).

FIG. 31 is a call flow for call hold—Mobile Originated (CDMA).

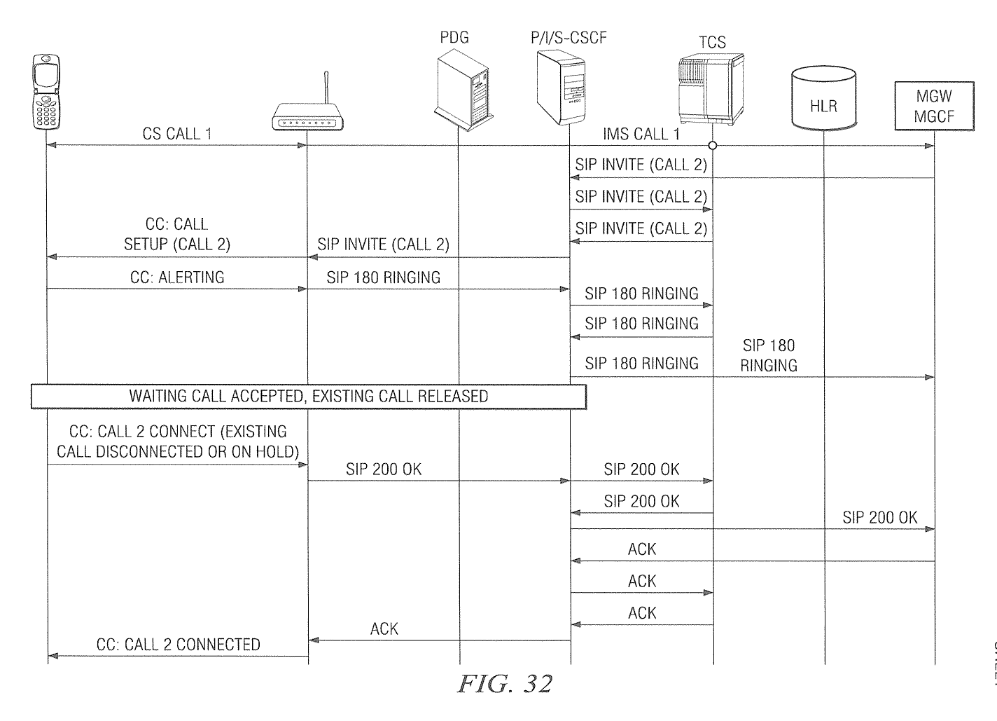

FIG. 32 is a call flow for call waiting (IMS).

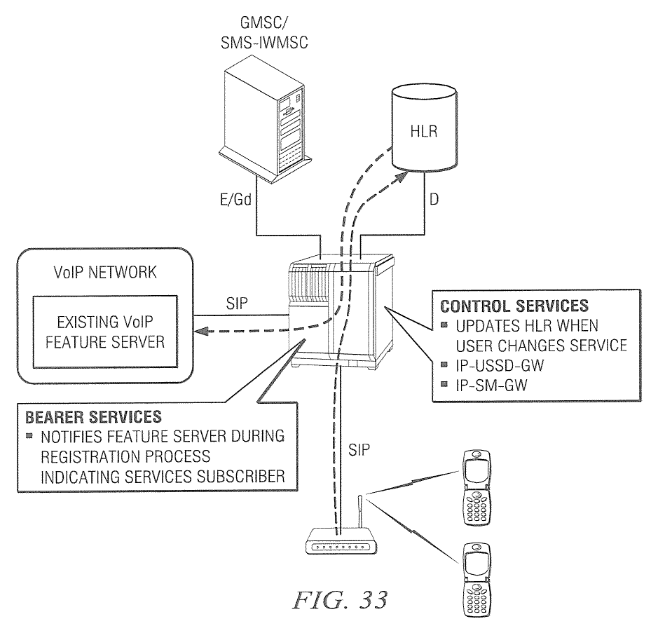

FIG. 33 is an alternative embodiment in which the convergence server facilitates supplementary services with an existing VoIP feature server.

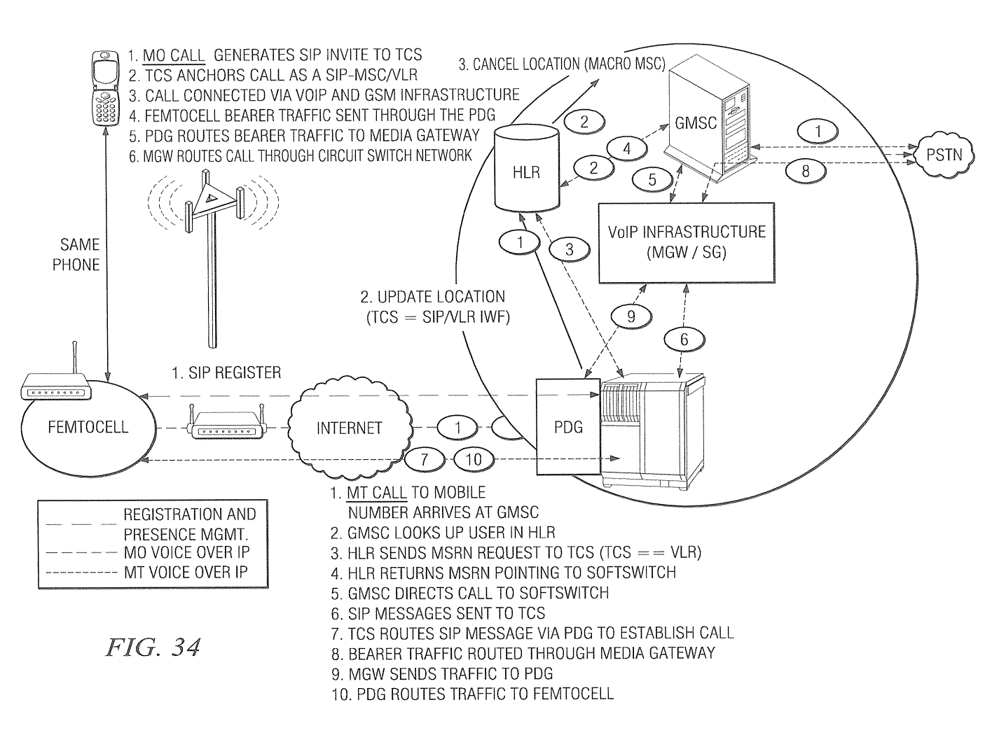

FIG. 34 provides additional details regarding voice call redirection to a femtocell according to the subject matter herein.

The SIP/IMS-based approach described above has a number of clear advantages. The solution is very scalable and does not load existing radio access or mobile core networks. The solution is able to offload IP-based calls completely to the IP or IMS network. Because of the SIP-based approach, the techniques described can be migrated seamlessly to IMS networks. The use of IP in the core network significantly reduces the operational and capital costs for carriers. As a result of its IP- and SIP-based architecture, this approach enables a number of new services into the femtocell environment. This allows operators to leverage the femtocell to generate new revenue for advanced services, instead of just being a landline replacement service or cannibalizing their own pure voice revenues.

While the above describes a particular order of operations performed by a given embodiment of the invention, it should be understood that such order is exemplary, as alternative embodiments may perform the operations in a different order, combine certain operations, overlap certain operations, or the like. References in the specification to a given embodiment indicate that the embodiment described may include a particular feature, structure, or characteristic, but every embodiment may not necessarily include the particular feature, structure, or characteristic.

Wile the disclosed subject matter has been described in the context of a method or process, the subject matter also relates to apparatus for performing the operations herein. This apparatus may be specially constructed for the required purposes, or it may comprise a general-purpose computer selectively activated or reconfigured by a computer program stored in the computer. Such a computer program may be stored in a computer readable storage medium including, without limitation, any type of disk including optical disks, CD-ROMs, and magnetic-optical disks, read-only memory (ROM), random access memory (RAM), magnetic or optical cards, or any type of media suitable for storing electronic instructions.

While given components of the system have been described separately, one of ordinary skill also will appreciate that some of the functions may be combined or shared in given instructions, program sequences, code portions, and the like. Finally, while the above text describes a particular order of operations performed by certain embodiments of the invention, it should be understood that such order is exemplary, as alternative embodiments may perform the operations in a different order, combine certain operations, overlap certain operations, or the like. References in the specification to a given embodiment indicate that the embodiment described may include a particular feature, structure, or characteristic, but every embodiment may not necessarily include the particular feature, structure, or characteristic.

### GLOSSARY

The following is a glossary of some of the terms used in this written description or used in the accompanying drawings.

SIP refers to the Session Initiation Protocol (SIP), which is a signaling protocol for Internet conferencing, telephony, presence, events notification and instant messaging;

HLR refers to the Home Location Register, a database to which a subscriber's identity is assigned for record and billing purposes;

IMS refers to an Internet Protocol (IP) Multimedia Subsystem, which provides signaling to control real time multimedia services for a packet domain in Universal Mobile Telecommunications System (UMTS) and CDMA networks and allows for smooth integration of new IP-based services. IMS defines a set of components: a Call Session Control Function (CSCF)—which acts as Proxy CSCF (P-CSCF) in a visited network, a Serving CSCF (S-CSCF) in a home network or Interrogating CSCF (I-CSCF) in a home network—to route and control session establishment; a Media Gateway Control Function (MGCF), which controls a Media Gateway and performs protocol conversion between ISUP and SIP; a Media Gateway (MGW), which interacts with MGCF for resource control, a Multimedia Resource Function (MRF), which controls media stream resources; a Breakout Gateway Control Function (BGCF), which selects the network in which PSTN breakout is to occur; and Application Servers, (AS), which offers value added services;

PDIF stands for Packet Data Interworking Function, which is an element defined by 3GPP2 to enable FMC networks. FMC refers to Fixed Mobile Convergence, which is the convergence of the wireless network and a fixed-line network. The PDIF allows access to a CDMA packet core and IMS network via WiFi access points. It is responsible for security, access, authentication, policy enforcement, data collection and the like.

PDG refers to a Packet Data Gateway.

UMTS refers to Universal Mobile Telecommunications System, which is a third-generation (3G) cell phone technology;

RADIUS is an IETF-defined client/server protocol and software that enables remote access servers to communicate with a central server to authenticate dial-in users and authorize their access to the requested system or service;

AAA refers to systems, devices, hardware and/or software that provide authentication, authorization and accounting functions;

MSC refers to a Mobile Switching Center, which is typically an interface between a base station system and a switching subsystem of a mobile phone network;

VLR refers to a Visitor Location Register, a local database function that maintains temporary records associated with individual subscribers.

SMSC is a network element in a mobile telephone network that delivers SMS messages; the machine(s) within a wireless service provider's network that provides the routing of all SMS or text messages. Like an email server, the SMSC handles large volumes of messages sent between two mobile phones or a mobile phone and a software application. An SMS internetworking MSC (SMS-IWMSC) is an MSC capable of receiving a short message from the mobile network and submitting it to a given SMSC.

Having described our invention, what we now claim is as follows.

1. A method of communicating within a converged networking operating environment wherein a gateway is deployed in a service provider's telecommunications network, the service provider's telecommunications network having a set of one or more network elements that comprise an infrastructure, and a database to which a mobile subscriber's identity is assigned, and wherein a connection is established between a femtocell and the gateway, the method comprising:
authenticating the femtocell;
upon detecting presence of a user's mobile device on the femtocell, attempting to authenticate the user's mobile device using information in the database;
upon successful authentication, updating presence for the user's mobile device to be the gateway; and
using the gateway to provide a service to the user's mobile device.

2. The method as described in claim 1 wherein the gateway provides a voice service.

3. The method as described in claim 1 wherein the gateway provides a message service.

4. The method as described in claim 1 wherein the gateway provides a supplementary service.

5. The method as described in claim 2 wherein the gateway provides voice call origination and termination between the infrastructure and the femtocell through the gateway.

6. The method as described in claim 5 wherein the database is an HLR and the gateway also enables one of: providing caller ID, voice mail system access and retrieval, message waiting indication, call forwarding, and call barring.

7. The method as described in claim 3 wherein the gateway enables incoming mobile terminated (MT) messages to the subscriber's mobile number to be terminated on the femtocell.

8. The method as described in claim 3 wherein for mobile originated (MO) messages, the gateway maintains the subscriber's mobile number as a source address.

9. The method as described in claim 3 wherein the supplementary service is an emergency service.

10. The method as described in claim 3 wherein the supplementary service is one of: call forwarding, three-way calling, call barring and call hold.

11. The method as described in claim 2 wherein the gateway also provides a mobility service during a voice call.

12. The method as described in claim 11 wherein the mobility service includes a handout from the femtocell to the service provider infrastructure.

13. The method as described in claim 11 wherein the mobility service includes a handin from the service provider infrastructure to the femtocell.

14. The method as described in claim 1 wherein the service provider's telecommunications network is an IMS network.

15. The method as described in claim 1 wherein the step of updating presence occurs in response to receipt of a Session Initiation Protocol (SIP) registration message.
